(19) United States
(12) Patent Application Publication
(10) Pub. No.: US 2025/0202668 A1
(43) Pub. Date: Jun. 19, 2025

(54) SELECTING A SUBSET OF ANTENNA PORT GROUPS

(71) Applicant: Lenovo (United States) Inc., Morrisville, NC (US)

(72) Inventors: Mahdi Barzegar Khalilsarai, Berlin (DE); Ahmed Hindy, Aurora, IL (US)

(21) Appl. No.: 19/065,813

(22) Filed: Feb. 27, 2025

(51) Int. Cl. H04L 5/00; H04W 24/10

(52) U.S. Cl. CPC H04L 5/0057; H04W 24/10

(57) ABSTRACT

Various aspects of the present disclosure relate to receiving, from a network node, a channel state information (CSI) reporting configuration; receiving a set of CSI reference signal (CSI-RS), wherein the set of CSI-RS is associated with a plurality of port groups; selecting a subset of port groups from the plurality of port groups, based on the received set of CSI-RS and the CSI reporting configuration; generating a CSI report comprising an indication of the selected subset of port groups and a channel measurement corresponding to the selected subset of port groups; and transmitting the CSI report to the network node.

### TECHNICAL FIELD

The present disclosure relates to wireless communications, and more specifically to techniques for selecting a subset of antenna port groups, for example, for energy saving in a large array.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The first wireless node may be configured to, capable of, or operable to receive, from a network node, a channel state information (CSI) reporting configuration; receive a set of CSI reference signal (CSI-RS), wherein the set of CSI-RS is associated with a plurality of port groups; select a subset of port groups from the plurality of port groups, based on the received set of CSI-RS and the CSI reporting configuration; generate a CSI report including an indication of the selected subset of port groups and a channel measurement corresponding to the selected subset of port groups; and transmit the CSI report to the network node.

A processor for wireless communication is described. In some examples, the processor may be implemented in a UE. The processor may be configured to, capable of, or operable to receive, from a network node, a CSI reporting configuration; receive a set of CSI-RS, wherein the set of CSI-RS is associated with a plurality of port groups; select a subset of port groups from the plurality of port groups, based on the received set of CSI-RS and the CSI reporting configuration; generate a CSI report including an indication of the selected subset of port groups and a channel measurement corresponding to the selected subset of port groups; and transmit the CSI report to the network node.

A method performed or performable by a UE is described. The method may include receiving, from a network node, a CSI reporting configuration; receiving a set of CSI-RS, wherein the set of CSI-RS is associated with a plurality of port groups; selecting a subset of port groups from the plurality of port groups, based on the received set of CSI-RS and the CSI reporting configuration; generating a CSI report including an indication of the selected subset of port groups and a channel measurement corresponding to the selected subset of port groups; and transmitting the CSI report to the network node.

A NE for wireless communication is described. In some examples, the NE may be implemented in a base station. The second wireless node may be configured to, capable of, or operable to transmit, to a UE, a CSI reporting configuration; transmit a set of CSI-RS, wherein the set of CSI-RS is associated with a plurality of port groups; receive a CSI report from the UE, the CSI report including an indication of a selected subset of port groups and a channel measurement corresponding to the selected subset of port groups; select a second subset of active port groups from the plurality of port groups, based on the received CSI report; and deactivate a remainder of the plurality of port groups.

A processor for wireless communication is described. In some examples, the processor may be implemented in a NE or a base station. The processor node may be configured to, capable of, or operable to transmit, to a UE, a CSI reporting configuration; transmit a set of CSI-RS, wherein the set of CSI-RS is associated with a plurality of port groups; receive a CSI report from the UE, the CSI report including an indication of a selected subset of port groups and a channel measurement corresponding to the selected subset of port groups; select a second subset of active port groups from the plurality of port groups, based on the received CSI report; and deactivate a remainder of the plurality of port groups.

A method performed or performable by a NE is described. In some examples, the NE may be implemented in a base station. The method may include transmitting, to a UE, a CSI reporting configuration; transmitting a set of CSI-RS, wherein the set of CSI-RS is associated with a plurality of port groups; receiving a CSI report from the UE, the CSI report including an indication of a selected subset of port groups and a channel measurement corresponding to the selected subset of port groups; selecting a second subset of active port groups from the plurality of port groups, based on the received CSI report; and deactivating a remainder of the plurality of port groups.

### BRIEF DESCRIPTION OF THE DRAWINGS

FIG. 1 illustrates an example of a wireless communications system in accordance with aspects of the present disclosure.

FIG. 2A illustrates an example of an antenna array including multiple antenna ports arranged into multiple port groups in accordance with aspects of the present disclosure.

FIG. 2B illustrates another example of an antenna array including multiple antenna ports arranged into multiple port groups in accordance with aspects of the present disclosure.

FIG. 3 illustrates an example of a procedure for selecting a subset of antenna port groups, in accordance with aspects of the present disclosure.

FIG. 4 illustrates another example of a procedure for selecting a subset of antenna port groups, in accordance with aspects of the present disclosure.

FIG. 5 illustrates a third example of a procedure for selecting a subset of antenna port groups, in accordance with aspects of the present disclosure.

FIG. 6 illustrates an example of an algorithm for optimizing a precoding matrix, in accordance with aspects of the present disclosure.

FIG. 7 illustrates an example of another algorithm for optimizing a precoding matrix, in accordance with aspects of the present disclosure.

FIG. 8 illustrates another example of an algorithm for determining block sparsity scalar, in accordance with aspects of the present disclosure.

FIG. 9 illustrates an example of a protocol stack, in accordance with aspects of the present disclosure.

FIG. 10 illustrates an example of a UE, in accordance with aspects of the present disclosure.

FIG. 11 illustrates an example of a processor, in accordance with aspects of the present disclosure.

FIG. 12 illustrates an example of a NE, in accordance with aspects of the present disclosure.

FIG. 13 illustrates a flowchart of a method performed by a first wireless node, in accordance with aspects of the present disclosure.

FIG. 14 illustrates a flowchart of a method performed by a second wireless node, in accordance with aspects of the present disclosure.

### DETAILED DESCRIPTION

Wireless communication systems may include a large number of antennas at a transmitter. The large number of antennas may yield several advantages, including simultaneously sending data to multiple spatial directions, an increase in received power at the receivers, and the simplification of resource allocation and link adaptation due to an effect known as “channel hardening.” These advantages have motivated the use of multiple-input multiple-output (MIMO), such as “massive MIMO” in the 4G and 5G wireless networks and have yielded significant gains in terms of coverage and throughput. In this regard, the 3rd Generation Partnership Project (3GPP) has specified various network aspects with up to 64 antenna ports at a gNB.

Wireless communication systems beyond 5G may utilize additional frequency bands such as the frequency range #3 (FR3) frequency band, in addition to the frequency range #1 (FR1) and frequency range #2 (FR2) bands. Compared to FR1, the signal wavelength in the FR3 band is smaller which enables a higher density of antenna elements at the transmitter and receiver arrays with roughly the same array form factor. Therefore, a natural increase in the number of antenna elements is envisioned, and the number of transmit antenna ports potentially increases to 128, 256, 512 or more.

A viable array architecture, especially suited to large arrays, consists of splitting the array into several sub-arrays, where each sub-array is controlled by a single radio frequency (RF) chain. This is because having a separate RF chain for each antenna element consumes an unaffordable amount of energy and the split offers a favorable flexibility in terms of the spatial resolution-energy consumption trade-off.

In other words, compared to a full-digital array in which each element has a dedicated RF chain, splitting the array into sub-arrays and dedicating one RF chain to each sub-array saves more energy, while still achieving a high spatial resolution. However, even with the above mentioned array architecture, with more antennas, the number of sub-arrays and associated RF chains also increases, requiring more complex signal processing and a much higher energy consumption.

Aspects of the present disclosure describe techniques for selecting a subset of the transmit antenna port groups dynamically deactivate, e.g., for network energy savings (NESs). In some example, the selection of “active” vs “inactive” port groups is done judiciously based on channel and interference conditions in order not to lose the gains that are available using a large array. This selection may additionally impact the CSI feedback overhead, in that if the receiver knows a priori which port groups might be activated, it can report only the CSI pertaining to the active port groups. Therefore, aspects the solutions described herein address the energy saving at the base station and the reduction of CSI feedback overhead.

While presented as distinct solutions, one or more of the solutions described herein may be implemented in combination with each other. Aspects of the present disclosure are described in the context of a wireless communications system.

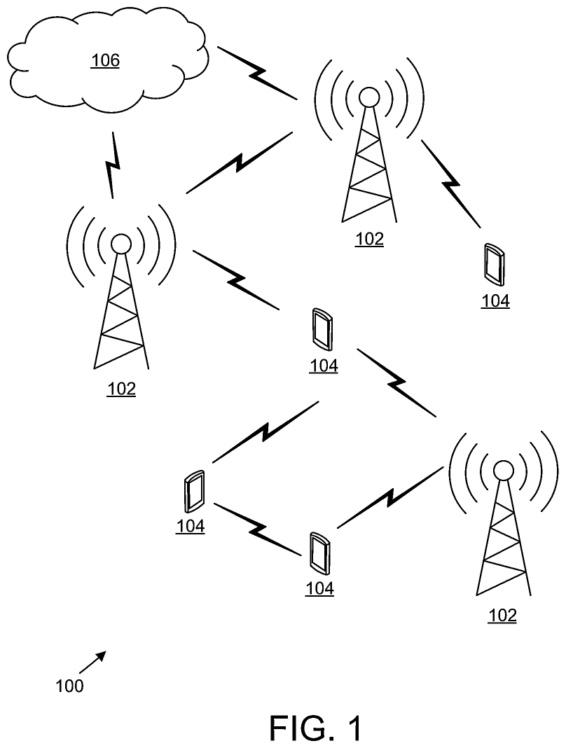

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (e.g., 410 MHz-7.125 GHZ), FR2 (e.g., 24.25 GHz-52.6 GHz), FR3 (e.g., 7.125 GHz-24.25 GHZ), frequency range #4 (FR4) (e.g., 52.6 GHz-114.25 GHZ), frequency range #4a (FR4a) or frequency range #4-1 (FR4-1) (e.g., 52.6 GHz-71 GHZ), and frequency range #5 (FR5) (e.g., 114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In some implementations, a respective UE 104 may receive, from an NE 102, a CSI reporting configuration. The UE 104 also receives a set of CSI-RS from the NE 102, such that the CSI-RS is received over a plurality of port groups, where each port group consists of a plurality of ports.

To reduce the CSI feedback overhead, the CSI reporting configuration may indicate a number of port groups for the UE 104 to report. The UE 104 identifies a subset of the set of the port groups, e.g., based on a set of metrics included within the CSI reporting configuration. The UE 104 may then generate a CSI report including an indication of the selected subset of port groups and a measure of the channel corresponding to the selected subset of port groups.

In some implementations, the NE 102 selects a set of active port groups for future communications based on the CSI reports of one or more UEs 104. Consequently, the NE 102 may deactivate the remainder of the port groups, e.g., to reduce power consumption.

Consider an NE 102 (e.g., a base station or gNB) equipped with an antenna array consisting of Nₛ port groups, where each port group consists of M antenna elements, hence a total of N_{T}=Nₛ·M antennas at the NE 102. One or more of the M antenna elements can be mapped to a “port” or “antenna port,” and the ports can be arranged into “port groups.”

A port group is determined by all the ports in that port group sharing some common hardware or signal processing resource with the possibility of being switched on and off together. For example, all antenna elements in a port group might be connected to a single RF chain or a few RF chains. This is done to reduce the cost of dedicating hardware to every element in a large array.

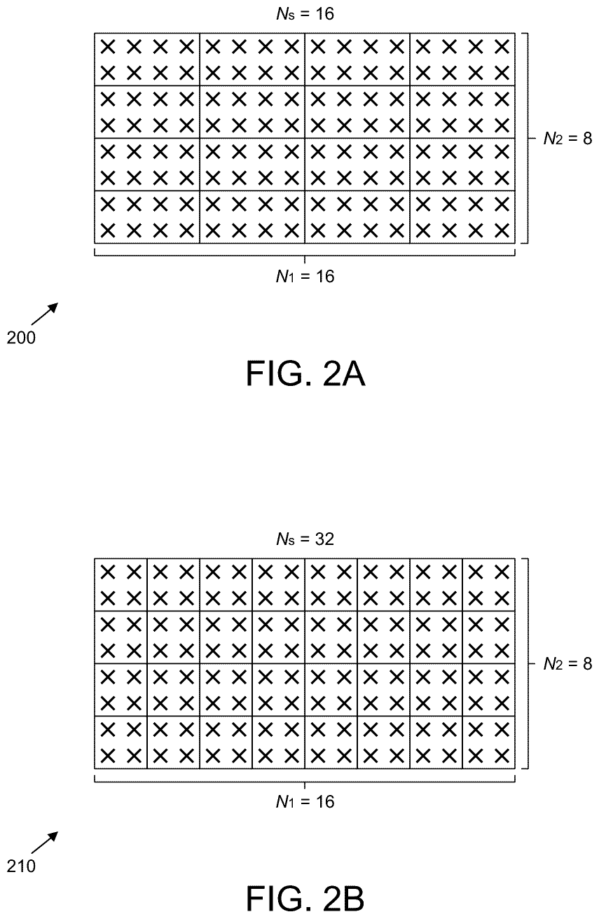

FIG. 2A illustrates an example of an antenna array 200 including multiple antenna ports arranged into multiple port groups in accordance with aspects of the present disclosure. In some examples, the antenna array 200 may be implemented at an NE 102. In the example of FIG. 2A, the antenna array 200 is a rectangular array with N₁=16 antenna element in a first dimension and N₂=8 antenna element in a second dimension, for a total of 128 antenna elements. In the depicted example, there are Nₛ=16 port groups each consisting of M =8 antenna elements.

FIG. 2B illustrates another example of an antenna array 210 including multiple antenna ports arranged into multiple port groups in accordance with aspects of the present disclosure. In some examples, the antenna array 210 may be implemented at an NE 102. In the example of FIG. 2B, the antenna array 210 is a rectangular array with N₁=16 antenna element in a first dimension and N₂=8 antenna element in a second dimension, for a total of 128 antenna elements. In the depicted example, there are Nₛ=32 port groups each consisting of M=4 antenna elements.

Consider that the NE 102 serves K UEs 104 simultaneously. Each UE 104 may be equipped with N_{R,k} antennas and can receive up to R layers of data. In the downlink (DL), the NE 102 transmits a vector of symbols:

$$a = {[ {a}_{1}^{T} , … , {a}_{K}^{T} ]}^{T}$$

where aₖ^{T} refers to the vector of symbols meant for UE k of dimension Sₖ and the dimension of a is S=Σₖsₖ. The symbols are randomly and independently generated from a constellation with unit variance, i.e., E[aa^{H}]=Iₛ. These symbols are transmitted in the DL via linear precoding as x=Pa where P is the precoding matrix of dimension N_{T}×S and consists of blocks of precoding matrices for each UE 104 as P=[P₁, . . . , P_{K}] where Pₖ consists of the precoding vectors of UE k and is of dimension N_{T}×Sₖ.

Note that the power allocated to each symbol in the subsequent formulation is included in the matrix P and there is a total transmit power constraint of

$$Tr ( {P}^{H} P ) = {P}_{tx} \qquad Eq . ( 1 )$$

for some Pₜₓ>0. The base-band model of the received signal at the UEs 104 is given by

$$y = HPa + z \qquad Eq . ( 2 )$$

where y=[y₁^{T}, . . . , y_{K}^{T}]^{T} is the vector of received signals at all UEs 104 and H of dimension N_{R}×N_{T} is the combined channel matrix of all UEs 104 that is given by

$$H = {[ {H}_{1}^{T} , … , {H}_{K}^{T} ]}^{T} \qquad Eq . ( 3 )$$

where N_{R}=Σₖ N_{R,k} and Hₖ of dimension N_{R,k}×N_{T} is the channel matrix of UE k.

The vector z is the additive noise with zero mean and covariance R_{zz}, and z=[Z₁^{T}, . . . , Z_{K}^{T}]^{T} where Zₖ is the additive noise at the receiver of UE k of dimension N_{R,k}, the UE k applies a combining matrix Vₖ of dimension sₖ×N_{R,k} to its received vector yₖ to obtain an estimate of its symbols âₖ=Vₖyₖ.

The vector of symbol estimates of all UEs 104 is given therefore by

$$\hat{a} = Vy = VHPa + Vz \qquad Eq . ( 4 )$$

where a=[a₁^{T}, . . . , a_{K}^{T}]^{T} and where

$$V = diag ( {V}_{1} , … , {V}_{K} ) \qquad Eq . ( 5 )$$

is the overall combining matrix of dimension S×Nᵣₓ. It is assumed that the number of symbols intended for each UE 104 is less than the number of its receive antennas (sₖ≤N_{rx,k}) and that the total number of symbols is less than the number of transmit antennas (S≤Nₜₓ).

Regarding the division to port groups, consider a transmit array consisting of Nₛ port groups that can be turned on or off. This implies that the precoding matrix P can be divided into blocks of N_{T} consecutive rows. The precoding coefficients of sub-array n therefore correspond to the n-th block of rows in P. i.e.,

$$P = [ \begin{matrix}{\tilde{P}}_{1} \\ ⋮ \\ {\tilde{P}}_{{N}_{s}}\end{matrix} ] \qquad Eq . ( 6 )$$

where \tilde{P}ₙ is a matrix of dimension

$$( \frac{{N}_{T}}{{N}_{s}} ) \times S ,$$

representing the precoding coefficients associated with port group n. The port groups are assumed to be of the same size and to consist of antennas with consecutive indices, for simplicity. None of these two assumptions is necessary, i.e., the port groups can have different sizes and can be associated with arbitrary antenna indices.

With this notation of the precoding matrix, if the block of rows in P corresponding to a port group is zero, then that port group is “inactive,” and it is “active” otherwise. Therefore the set of active port groups can be defined as

$${S}_{active} = \{ n : {‖ {\tilde{P}}_{n} ‖}_{F} \neq 0 \} , \qquad Eq . ( 7 )$$

where |·|_{F} denotes Frobenius norm. The cardinality (i.e., number of elements) of S_{active} is denoted by Nₐ. For balancing performance with power savings, one goal is to minimize Nₐ while keeping performance within a margin of what is achievable when utilizing the full array.

In one example, if all port groups were activated, the average throughput received by the UEs 104 is some value T*. In the selection of the port groups, it is desirable to activate as few port groups as possible such that the average throughput with the sub-selected array is no less than α T* where α∈(0,1) is a fraction. The average throughput can be replaced by the maximum or the minimum throughput or any other function of the set of achieved throughputs by all the UEs 104.

In another example, if all port groups were activated the average mean squared error (MSE) in estimating the transmitted symbols at the UEs 104 is given by some value E*. In selection of the port groups it is desirable to activate as few port groups as possible such that the MSE with the sub-selected array is no larger than βE* where β>1.

The selection of the active port groups inherently depends on the UE CSI that is available at the NE 102. In time division duplexing (TDD), this CSI is obtained via uplink (UL) reference signals (SRS) and by relying on UL-DL channel reciprocity. In frequency division duplexing (FDD), the CSI is obtained by sending DL reference signals (CSI-RS) and receiving feedback from the UEs 104. The CSI consists of four fields: the precoding matrix indicator (PMI), the rank indicator (RI), the wideband and subband channel quality indicator (CQI). The PMIs are computed based on pre-defined codebooks.

Regarding the 3GPP NR Release 15 (Rel-15) Type-II Codebook, it is assumed that the NE 102 (e.g., a gNB) is equipped with a two-dimensional (2D) antenna array with N₁, N₂ antenna ports per polarization placed, with N₁ being the horizontal dimension and N₂ being the vertical dimension of the array. In the frequency domain (FD), communication occurs over N₃ PMI subbands. A PMI subband consists of a set of resource blocks (RBs), each RB consisting of a set of subcarriers. Considering dual polarization, there are 2N₁N₂ CSI-RS ports which are utilized to enable DL channel estimation with high resolution for the NR Rel-15 Type-II codebook. Further details on NR codebook types can be found in 3GPP Technical Specification (TS) 38.214.

In order to reduce the UL feedback overhead, a discrete Fourier transform (DFT)-based transformation is used to project the channel onto L spatial beams (shared by both polarizations) where L<N₁N₂. In the following, the indices of the L dimensions are referred as the spatial domain (SD) basis indices. The magnitude and phase values of the 2L linear combination coefficients for each subband are fed back to the NE 102 as part of the CSI report. The 2N₁N₂×N₃ codebook per transmission layer/takes on the form:

W=W₁W_{2,l}
where the matrix W₁ is a 2N₁N₂×2L, block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:2

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] \\ {ν}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} \\ B = [ {ν}_{{l}_{0} , {m}_{0}} {ν}_{{l}_{1} , {m}_{1}} … {ν}_{{l}_{L - 1} , {m}_{L - 1}} ] \\ {l}_{i} = {O}_{1} {n}_{1}^{( i )} + {q}_{1} , 0 \leq {n}_{1}^{( i )} < {N}_{1} , 0 \leq {q}_{1} < {O}_{1} \\ {m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript^{T} denotes a matrix transposition operation. O₁, O₂ are oversampling factors, assumed for the 2D DFT matrix from which matrix B is drawn.

The matrix W₁ is common across all transmission layers. The matrix W_{2,l} is a 2L×N₃ matrix, where the i^{th} column corresponds to the linear combination coefficients of the 2L beams in the i^{th} subband. Only the indices of the L selected columns of B are reported, along with the oversampling index taking on O₁O₂ values. W_{2,l} are independent for different transmission layers.

Regarding 3GPP NR Rel-15, for Type-II port selection codebook, only K (where K≤2N₁N₂) beamformed CSI-RS ports are utilized in DL transmission, in order to reduce complexity. The K×N₃ codebook matrix per transmission layer l takes on the form:

W=W₁^{PS}W_{2,l}

Here, the matrices W_{2,l} follow the same structure as the conventional NR Rel-15 Type-II codebook, and are transmission layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} \begin{matrix} \\ \end{matrix} ] ,$$

and E is a

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is a radio resource control (RRC) parameter which takes on the values {1,2,3,4} under the condition d_{PS}≤ min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. The matrix W₁^{PS} is common across all transmission layers.

For K=16, L=4 and d_{PS}=1, the 8 possible realizations of E corresponding to m_{PS}={0,1, . . . ,7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for RI=1,2, wherein a phase coupling value is reported for each subband, i.e., W_{2,l} is 2×N₃, with the first row equal to [1, 1, . . . , 1] and the second row equal to

$$[ {e}^{j 2 π {∅}_{0}} , … , {e}^{j 2 π {∅}_{{N}_{3} - 1}} ] .$$

Under specific configurations, ϕ₀=ϕ₁. . . =ϕ, i.e., wideband reporting. For RI>2, different beams are used for each pair of transmission layers. The NR Rel-15 Type-I codebook may be depicted as a low-resolution version of NR Rel-15 Type-II codebook with spatial beam selection per transmission-layer-pair and phase combining only.

Regarding the 3GPP NR Release 16 (Rel-16) Type-II codebook, it is assumed that the NE 102 is equipped with a 2D antenna array with N₁, N₂ antenna ports per polarization placed, with N₁ being the horizontal dimension and N₂ being the vertical dimension of the array. In the FD, communication occurs over N₃ PMI subbands. A PMI subband consists of a set of RBs, each RB consisting of a set of subcarriers. Considering dual polarization, the are 2N₁N₂N₃ CSI-RS ports which are utilized to enable DL channel estimation with high resolution for NR Rel-16 Type-II codebook. In order to reduce the UL feedback overhead, a DFT-based transformation is used to project the channel onto L spatial beams (shared by both polarizations) where L<N₁N₂. Similarly, additional compression in the FD is applied, where each beam of the FD precoding vectors is transformed using an inverse DFT matrix to the delay domain, and the magnitude and phase values of a subset of the delay-domain coefficients are selected and fed back to the NE 102 as part of the CSI report.

The 2N₁N₂×N₃ codebook per transmission layer l takes on the form:

W=W₁\tilde{W}_{2,l}W_{f,l}^{H}
where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {ν}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} , \\ B = [ {ν}_{{l}_{0} , {m}_{0}} {ν}_{{l}_{1} , {m}_{1}} … {ν}_{{l}_{L - 1} , {m}_{L - 1}} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation, and the superscript ^{H} denotes a matrix Hermitian, i.e., conjugate transposition operator. O₁, O₂ oversampling factors are assumed for the 2D DFT matrix from which matrix B is drawn. W₁ is common across all transmission layers. In various embodiments, the above parameters comply with 3GPP TS 38.214 definitions and procedures.

Each matrix W_{f,l} is an N₃×M matrices (where M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{{}_{′}} - 1}} ] , 0 \leq {k}_{i}\end{matrix} \leq {N}_{3} - 1 \\ {f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T}$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred to as the selected FD basis indices. Hence, L and M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}_{2,l}, W_{f,l} are selected independently for different transmission layers.

Amplitude and phase values of an approximately β fraction of the 2LM available coefficients are reported to the NE 102 (β<1) as part of the CSI report. One or more coefficients with zero magnitude are indicated via a per-layer bitmap. Since all coefficients reported within a transmission layer are normalized with respect to the coefficient with the largest magnitude (strongest coefficient), the relative value of that coefficient is set to unity (i.e., one), and no magnitude or phase information is explicitly reported for this coefficient. Only an indication of the index of the strongest coefficient per transmission layer is reported. Hence, amplitude and phase values of a maximum of [2βLM]-1 coefficients (along with the indices of selected L, M DFT vectors) are reported per transmission layer, leading to significant reduction in CSI report size, compared with reporting 2N₁N₂×N₃-1 coefficients' information of a theoretical design.

Regarding 3GPP NR Rel-16, for Type-II port selection codebook, only K (where K≤2N₁N₂) beamformed CSI-RS ports are utilized in DL transmission, in order to reduce complexity. The K×N₃ codebook matrix per transmission layer l takes on the form:

W =W₁^{PS}\tilde{W}_{2,l}W_{f,l}^{H}

Here, \tilde{W}_{2,l} and W_{f,l} follow the same structure as the conventional NR Rel-16 Type-II Codebook, described above, where both are transmission layer specific. The matrix W₁^{PS} is a K×2L block-diagonal matrix with the same structure as that in the NR Rel-15 Type-II port selection codebook, described above.

The 3GPP NR Release 17 (Rel-17) Type-II port selection codebook follows a similar structure as that of Rel-15 and Rel-16 Type-II port selection codebooks, as follows:

Wₗ=W̅₁^{PS}\tilde{W}_{2,l}W_{f,l}^{H}.
where the superscript ^{H} denotes a matrix Hermitian, i.e., conjugate transposition operator.

Here, \tilde{W}_{2,l} and W_{f,l} follow the same structure as the conventional NR Rel-16 Type-II Codebook; however M is limited to 1,2 only, with the network configuring a window of size N={2,4} for M=2. Moreover, the bitmap is reported unless β=1 and the UE reports all the coefficients for a rank up to a value of two.

However, unlike Rel-15 and Rel-16 Type-II port selection codebooks, the port-selection matrix W̅₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers.

Regarding codebook reporting, the CSI codebook report may be partitioned into two parts based on the priority of information reported. Each part may be encoded separately. Part 1 of the CSI codebook report may possibly have a higher code rate. Below is listed list the parameters for NR Rel-16 Type-II codebook only. More details can be found in 3GPP TS 38.214, Sections 5.2.3 and 5.2.4.

Regarding the contents of the CSI report, Part 1 of the CSI report includes a RI, plus a CQI, plus the total number of coefficients (i.e., represented using a single value). Part 2 of the CSI report includes an SD basis indicator, plus an FD basis indicator per layer, plus a bitmap per layer, plus coefficient amplitude information per layer, plus coefficient phase information per layer, plus a strongest coefficient indicator per layer.

Furthermore, Part 2 of the CSI report can be decomposed into sub-parts each with different priorities (higher priority information listed first). Such partitioning is required to allow dynamic reporting size for codebook based on available resources in the uplink phase. More details can be found in 3GPP TS 38.214, Section 5.2.3.

Also Type-II codebook is based on aperiodic CSI reporting, and only reported on physical uplink shared channel (PUSCH) via downlink control information (DCI) triggering (one exception). Type-I codebook can be based on periodic CSI reporting (i.e., using physical uplink control channel (PUCCH)) or semi-persistent (SP) CSI reporting (i.e., using PUSCH or PUCCH) or aperiodic (AP) reporting (i.e., using PUSCH).

Regarding CQI reporting, a CSI report may include a CQI report quantity corresponding to channel quality assuming a target maximum transport block (TB) error rate, which indicates a modulation order, a code rate and a corresponding spectral efficiency associated with the modulation order and code rate pair. Examples of the maximum TB error rates are 0.1 and 0.00001. The modulation order can vary from quadrature phase shift keying (QPSK) up to 1024 quadrature amplitude modulation (QAM), whereas the code rate may vary from 30/1024 up to 948/1024. One example of a CQI table for a 4-bit CQI indicator that identifies a possible CQI value with the corresponding modulation order, code rate and efficiency is provided in Table 1, as follows.

TABLE 1
Example of a 4-bit CQI table

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each physical downlink shared channel (PDSCH) TB, and a subband format, wherein one wideband CQI value is reported for the entire TB, in addition to a set of subband CQI values corresponding to CQI subbands on which the TB is transmitted. CQI subband sizes are configurable, and depend on the number of physical resource blocks (PRBs) in a bandwidth part (BWP), as shown in Table 2.

TABLE 2
Configurable subband sizes for a given BWP size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, i.e., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as: Sub-band Offset level(s)=sub-band CQI index(s)−wideband CQI index.

The mapping from the 2-bit sub-band differential CQI values to the offset level is shown in Table 3, as follows:

TABLE 3
Mapping subband differential CQI value to offset level

| Sub-band differential CQI value | Offset level |
|---|---|
| 0 | 0 |
| 1 | 1 |
| 2 | ≥2 |
| 3 | ≤−1 |

Also, multiple tables corresponding to mapping CQI indices to modulation and coding schemes may exist. For instance, Table 4 may correspond to a first CQI table with modulation and coding schemes that correspond to enhanced mobile broadband (eMBB)-based transmission, whereas Table 5 may correspond to a first CQI table with modulation and coding schemes that correspond to ultra reliable low latency communication (URLLC)-based transmission. An eMBB-based DL transmission and URLLC-based DL transmission correspond to two different thresholds of TB error probability, wherein the threshold of the TB error probability corresponding to the URLLC-based DL transmission, e.g., 0.00001 is lower than the threshold of the TB error probability corresponding to the eMBB-based DL transmission, e.g., 0.1.

TABLE 4
CQI Table corresponding to eMBB-based DL transmission

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 5
CQI Table corresponding to URLLC-based DL transmission

| | | | |
|---|---|---|---|
| CQI index | modulation | code rate × 1024 | efficiency |

| | |
|---|---|
| 0 | out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

As described above, with more antennas in the antenna array, the number of sub-arrays and associated RF chains also increases, requiring more complex signal processing and a much higher energy consumption. In the following, techniques are described to dynamically “turn off” (i.e., deactivate) a subset of transmit antenna port groups to save energy. The selection of “active” vs “inactive” port groups is done judiciously based on channel and interference conditions in order not to lose the gains that are available using a large array. This selection of antenna port groups may additionally impact the CSI feedback overhead, in that if the receiver knows a priori which port groups might be activated, it can report only the CSI pertaining to the active port groups. Therefore, aspects the solutions described herein address the energy saving at the base station and the reduction of CSI feedback overhead.

For 3GPP NR Release 18 (Rel-18) NES enhancements in the SD focus on dynamically adjusting or selectively deactivating antenna elements (e.g., beamforming resources) to reduce power consumption, particularly in low-traffic scenarios. By adapting the SD (e.g., the number of active antennas, beam patterns, or transmission layers), the network can save energy while still meeting service requirements. Conventional techniques for implementing this, as summarized below.

Type 1 SD adaptation may also be referred to as antenna port adaptation. Here, different subsets of ports of a CSI-RS resource are selected for different spatial adaptation patterns, corresponding to CSI reporting sub-configurations. The objective is to enable comparison of channel quality via CSI reporting of two sub-reports. As an example, four (4) CSI sub-configurations (e.g., bitmaps) may be associated with four different, static antenna patterns. In some examples, one antenna pattern may be characterized by alternating rows of antenna ports (or antenna port groups) being activated/deactivated. In some examples, another antenna pattern may be characterized by alternating columns of antenna ports (or antenna port groups) being activated/deactivated. In other examples, both alternating rows and alternating columns of antenna ports (or antenna port groups) may be deactivated.

Type 2 SD adaptation may also be referred to as antenna element adaptation. Here, different antenna elements are selected per CSI-RS port corresponding to different CSI reporting sub-configurations. Same CSI-RS port number and layout. Again, the objective is to enable comparison of channel quality via CSI reporting of two sub-reports. As an example, two (2) CSI sub-configurations (i.e., different CSI-RS resources) may be associated with two different, static antenna patterns. In some examples, one antenna pattern may be characterized by alternating rows of antenna ports (or antenna port groups) being activated/deactivated. In some examples, another antenna pattern may be characterized by alternating columns of antenna ports (or antenna port groups) being activated/deactivated.

In each of the above SD adaptation types, the UE is configured with multiple sub-configurations, each of which are associated with separate CSI calculations and separate CSI reporting in the form of multiple CSI sub-reports, each computed separately. In some examples, different sub-configurations may require separate CSI-RS transmission as well.

An earlier disclosure of the inventors described a framework for efficient CSI measurement and reporting, thereby enabling the configuration of spatial adaptation patterns that allow the use of current CSI codebooks. In other words, the inventors identified antenna port patterns, as subsets of the full array, for which CSI can be reported without needing to define a new CSI codebook (i.e., these configurations were enabled with legacy codebooks). These antenna port patterns are described in further detail in U.S. application Ser. No. 18/903,891 entitled “RECONFIGURABLE PRECODING ALGORITHM FOR DFT-BASED CODEBOOK DESIGN” and filed on Oct. 1, 2024, for Ahmed Hindy and Mahdi Barzegar Khalilsarai, which application is incorporated herein by reference.

The present disclosure described techniques for signaling feedback (e.g., between transmitter and receiver) that enables the dynamic selection of active antenna port groups with reduced DL reference signal (RS) and CSI feedback overhead, as well as reduced energy consumption.

A solution for the problem of selecting active port groups is as follows. The NE 102 (e.g., gNB) transmits RS corresponding to the all antenna ports. In one implementation, the UE 104 receives CSI-RS including a plurality of all ports, the number of ports being a product of the number of port groups and the number of antennas per port group (i.e., MNs CSI-RS ports). Then, the UE 104 estimates the DL channel from the received RS and reports a signal that is a function of the channel to the NE 102.

In one example, the UE 104 may report the CSI fields corresponding to all of the CSI-RS ports, namely the RI, CQIs (wideband and sub-band) and PMI. In particular, the PMI contains the index of an element of a CSI codebook, where the elements of the codebook correspond to precoding matrices in which one dimension is equal to the number of CSI-RS ports.

In a second example, the UE 104 may report the raw estimated channel matrix. The raw channel coefficients can be quantized with a very high-resolution scalar or vector quantizer. The advantage of this approach is that the NE 102 has almost the full information about the channel, beyond what is given by the precoding matrix. However, the incurred feedback overhead will be larger compared to reporting CSI fields.

In a third example, the UE 104 may report a measure of the channel coefficients for each port group.

After this, the NE 102 collects feedback from all UEs 104 and selects the active port groups and the precoding coefficients corresponding to them.

In the case of single-user MIMO (SU-MIMO) transmission, the active port groups are selected based on a measure of channel gain corresponding to each port group. In one example, the NE 102 computes the Frobenius norm of the reported raw channel coefficients or the reported precoding coefficients per port group, sorts them and picks the Nₐ port groups with the largest Frobenius norm. In another example, the NE 102 estimates the UE throughput when progressively more port groups are activated and picks a number of port groups such that the estimated throughput is within a margin of the throughput estimated for the full array.

In the case of multi-user MIMO (MU-MIMO) transmission, the active port groups are selected based not only on the channel gain per port group, but also the inter-user interference. In this case the selection of port groups is more complicated, because for example it may happen that activating a port group contributes to a large channel gain for one UE 104 but induces a large interference on the other UEs 104.

Additional techniques for selecting the active port groups are described below which apply to both SU-MIMO and MU-MIMO cases. This method is based on minimizing MSE in symbol estimation, while constraining the number of active port groups. Although the baseline method enables the selection of port groups at the base station, further benefit is achieved by decreasing the CSI overhead and the complexity of computing the CSI report, as described below.

Accordingly, the solutions described herein reduce the transmit energy and complexity of communication with large MIMO arrays. These solutions are based on a dynamic selection of active port groups at the network side, based on either UL reference signals (e.g., in TDD) or UE CSI feedback (e.g., in FDD and TDD). The solutions described herein also reduce feedback overhead, by limiting the feedback to a subset of antennas (port groups) selected at the NE 102. For the task of selecting port groups, a principled method is described that can be implemented at the NE 102 to minimize the average symbol error rate among all UEs 104 while restricting the number of active port groups to a fixed number.

Described herein are techniques for CSI-RS transmission and feedback in order to enable a suitable selection of active antenna port groups. In the case of reciprocity-based precoding (e.g., in TDD and based on SRS) the problem is simplified, since the NE 102 has direct access to channel estimates for all UEs 104 from the UL RS and the problems of DL RS and feedback overhead are irrelevant in that case. Therefore here the following solutions only focus on the case where CSI is acquired at the NE 102 via feedback. For each case, the techniques described can be used at the NE 102 to select the active port groups.

According to aspects of the first solution, a UE received RS associated with all antenna ports and estimates the full channel, i.e., the UE measures all RS and estimates the channel over all RS. However, the UE selects a subset of port groups (e.g., based on one or more criteria indicated by the network) and only reports the indices of the selected port groups and the CSI (and/or other channel measurements) associated with the selected port groups. Beneficially, this reduces the CSI feedback overhead and the network then uses the CSI feedback to selectively deactivate port groups, thereby reducing network energy consumption.

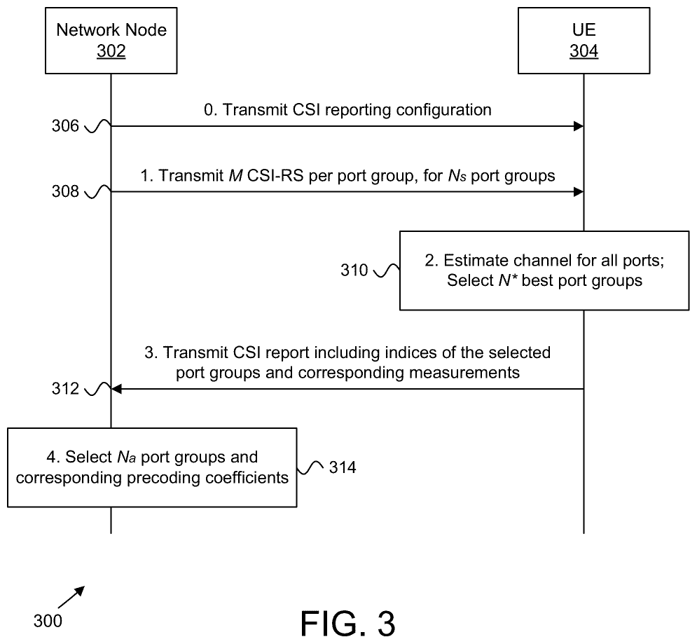

FIG. 3 illustrates an example of a procedure 300 for selecting a subset of antenna port groups, in accordance with aspects of the present disclosure. The procedure 300 may implement or be implemented by aspects of the wireless communication system 100. For example, the procedure 300 may be performed between a network node 302, which may be an example of the NE 102, and a UE 304, which may be an example of the UE 104, as described herein.

It is assumed that the network node 302 (e.g., a gNB) is equipped with an antenna array consisting of Nₛ port groups, where each port group consists of M antenna elements, hence a total of N_{T}=Nₛ·M antennas at the network node 302. The steps of the procedure 300 are described as follows:

At step 0, the network node 302 configures the UE 304 for CSI measurement and reporting, i.e., by transmitting a CSI reporting configuration (see signaling 306).

At step 1, the UE 304 receives CSI-RS from the network node 302 corresponding to a plurality of ports (see signaling 308). The number of CSI-RS received is a product of the number of port groups and the number of antennas per port group (i.e., Nₛ·M CSI-RS ports).

At step 2, the UE 304 estimates the channel for all ports and based on this estimate selects N* port groups according to a criterion (see block 310). In some examples, N* is configured by the network node 302 (e.g., in the CSI reporting configuration of Step 0). Alternatively, the network node 302 may configure a maximum value for N*.

At step 3, the UE 304 then reports the indices of the selected port groups to the network node 302 as part of the CSI feedback (see signaling 312). In one example, the N* port groups are chosen by sorting the channel gains associated with port groups (e.g., the Frobenius norm of the estimated channel coefficients) and picking the N* port groups with the largest gains. In another example, the UE 304 computes the wideband CQI or the average sub-band CQI for each port group and picks N* port groups which have the largest values.

In addition to the indices of the selected port groups, the UE 304 sends a measure of the channel corresponding to the selected N* port groups to the network node 302. The measure of the channel can be reported in several different ways. In one example, the UE 304 computes PMI for each port group separately and reports them to the network node 302. The total overhead of reporting PMI for the selected port groups is less than the overhead of reporting the PMI for the entire array.

In a second example, the RI and CQIs can be either reported for each port group separately or a single value of RI, wideband CQI and sub-band CQI can be reported for all of the selected port groups. In a third example, the UE 304 may transmit the raw channel coefficients associated with the selected port groups to the network node 302.

At step 4, after receiving feedback from all of the UEs 304, the network node 302 selects Nₐ port groups and selects precoding coefficients corresponding to these port groups based on the reported CSI from the UEs 304 (see block 314). In one implementation, e.g., where single-user MIMO operation is performed, the value of Nₐ can be smaller than N* since the network node 302 only has access to CSI for N* port groups.

In another implementation, e.g., where multi-user MIMO is performed, the value of Nₐ (i.e., the number of activated port groups) might be larger than N* because different UEs 304 might prefer different sets of active port groups.

According to aspects of the second solution, a UE receives two sets of RS, one set associated with all antenna ports and the other set being a reduced set associated with the antenna port groups. The UE computes the channel gain of each port group and selects a subset of port groups (e.g., based on one or more criteria indicated by the network). The UE then measures the RS only corresponding to selected port groups and reports the indices of the selected port groups and the CSI (and/or other channel measurements) associated with the selected port groups. Beneficially, this reduces the CSI feedback overhead and the network then uses the CSI feedback to selectively deactivate port groups, thereby reducing network energy consumption. Additionally, this solution reduces the UE-side complexity of generating the CSI feedback; however, the second solution has increased DL RS overhead as compared to the first solution.

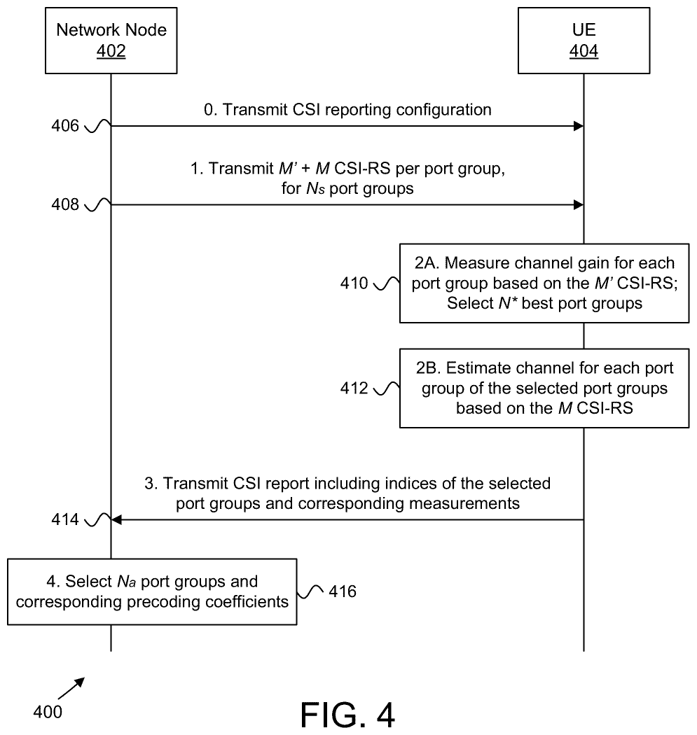

FIG. 4 illustrates an example of a procedure 400 for selecting a subset of antenna port groups, in accordance with aspects of the present disclosure. The procedure 400 may implement or be implemented by aspects of the wireless communication system 100. For example, the procedure 400 may be performed between a network node 402, which may be an example of the NE 102, and a UE 404, which may be an example of the UE 104, as described herein.

It is assumed that the network node 402 (e.g., a gNB) is equipped with an antenna array consisting of Nₛ port groups, where each port group consists of M antenna elements, hence a total of N_{T}=Nₛ·M antennas at the network node 402. The steps of the procedure 300 are described as follows:

At step 0, the network node 402 configures the UE 404 for CSI measurement and reporting, i.e., by transmitting a CSI reporting configuration (see signaling 406).

At step 1, in one implementation, the UE 404 receives a number of RS M′+M per port group, where the total number of RS resources is the product of the number of port groups and the number of port groups (M′+M)·Nₛ (see signaling 408).

In one implementation, M′ is equal to one, namely a single RS per port group is received by the UE 404. In another implementation, each RS in the M′ RSs is quasi-co-located (QCLed) with an RS associated with the M ports corresponding to the same port group.

At step 2A, based on a first subset of the received reference signal, in particular the M′·Nₛ ports, the UE 404 computes a measure of channel gain for each port group (see block 410). In one implementation, the UE 404 then selects a subset of N* port groups based on the measurement of the M′·Nₛ ports, where N*<N is configured by the network node 402 (e.g., in the CSI reporting configuration of Step 0). Alternatively, the network node 402 may configure a maximum value for N*.

At step 2B, the UE 404 then measures the channel corresponding to all ports of the selected N* port groups, i.e., M·N* ports (see block 412). Under this implementation, the number of RSs measured by the UE 404 is M′·Nₛ+M·N*. In one example, if M′=1, M=32, Nₛ=8 and N*=2, the UE 404 would measure 72 RSs rather than 256 RSs (i.e., M·N* RSs).

At step 3, the UE 404 reports the indices of the N* selected port groups, along with the CSI for the M·N* ports associated with the N* selected port groups (see signaling 414).

At step 4, after receiving feedback from all of the UEs 404, the network node 402 selects Nₐ port groups and selects precoding coefficients corresponding to these port groups based on the reported CSI from the UEs 404 (see block 416).

According to aspects of the third solution, the network performs a two-stage procedure for CSI-RS transmission and feedback. In a first stage, the UE receives a reduced set of RS associated with the antenna port groups and measures the channel gain of each port group. The UE selects a subset of port groups (e.g., based on one or more criteria indicated by the network) and reports the of the selected port groups to the network. In a second stage, the network selects a second subset of port groups and sends a second set of RS associated with the antenna ports of the second subset. The UE then reports the CSI (and/or other channel measurements) associated with the second subset of port groups. Beneficially, this reduces the CSI feedback overhead and the network then uses the CSI feedback to selectively deactivate port groups, thereby reducing network energy consumption. Additionally, this solution reduces the DL RS overhead and the UE-side complexity of generating the CSI feedback; however, the third solution has increased delay as compared to the first and second solutions.

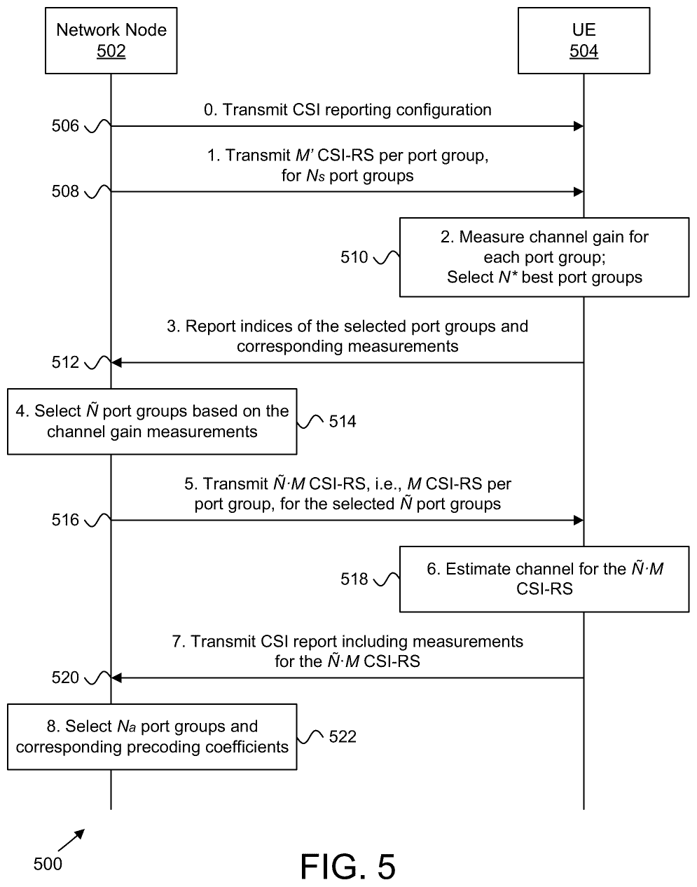

FIG. 5 illustrates an example of a procedure 500 for selecting a subset of antenna port groups, in accordance with aspects of the present disclosure. The procedure 500 may implement or be implemented by aspects of the wireless communication system 100. For example, the procedure 500 may be performed between a network node 502, which may be an example of the NE 102, and a UE 504, which may be an example of the UE 104, as described herein.

It is assumed that the network node 502 (e.g., a gNB) is equipped with an antenna array consisting of Nₛ port groups, where each port group consists of M antenna elements, hence a total of N_{T}=Nₛ·M antennas at the network node 502. The steps of the procedure 300 are described as follows:

At step 0, the network node 502 configures the UE 504 for CSI measurement and reporting, i.e., by transmitting a CSI reporting configuration (see signaling 506).

At step 1, in one implementation, the UE 504 receives a number of RS M′ per port group, where the total number of RS resources is the product of the number of port groups and the number of port groups M′Nₛ (see signaling 508). In one example, M′ is equal to one, namely a single RS per port group is received by the UE 504.

At step 2, based on the received RS, the UE 504 computes a measure of channel gain for each port group and selects a subset of N* port groups (see block 510). Here, N* may be configured by the network node 502 (e.g., in the CSI reporting configuration of Step 0) and can be equal to Nₛ, i.e., the number of all port groups. Alternatively, the network node 502 may configure a maximum value for N *.

At step 3, the UE 504 then reports the indices of the selected port groups to the network node 502 (see signaling 512). In one implementation, in addition to the indices of the selected port groups, the UE 504 also reports a measure of the channel gain for the subset of N* port groups.

Alternatively, the UE 504 may report only the indices of those port groups whose gain falls below a certain threshold, to indicate to the network node 502 that the radio channel of an indicated port group is too weak and should not be selected.

At step 4, based on the received measures of channel gains from all UEs, the network node 502 selects Ñ port groups, where Ñ is an intermediate number of port groups (see block 514).

At step 5, the network node 502 then transmits Ñ·M reference signals to the UEs 504, where Ñ is an intermediate number of port groups (see signaling 516). Since the DL RS are common among for all UEs 504 (i.e., they are not beamformed towards a specific UE 504), the value of Ñ can be generally larger than N*, e.g., to cover ports corresponding to selected port groups by several different UEs 504.

At step 6, the UE 504 estimates the channel corresponding to the Ñ·M reference signals, i.e., transmitted in Step 5 (see block 518).

At step 7, the UE 504 reports, to the network node 502, a measure of the channel corresponding to the ÑM reference signals (see signaling 520). In one example the UE 504 sends CSI corresponding to the Ñ·M reference signals. In another example the UE 504 sends raw channel coefficient values to the network node 502 using a quantization method that quantizes the continuous-valued coefficients.

At step 8, after receiving feedback from all of the UEs 504, the network node 502 selects a final subset of Nₐ active port groups and their corresponding precoder coefficients (see block 522), e.g., based on the CSI feedback reports received from one or a plurality of the UEs 504.

This approach can be seen as a coarse-to-fine CSI reporting, where in the first stage the network probes the UEs to find a coarse measure of their channel gains for each port group and in the second stage, the network asks for fine CSI reports for a limited subset of port groups. This type of two-stage CSI reporting can reduce both the number of CSI-RS resources and the feedback overhead from the UEs. This is because instead of reporting CSI for NₛM ports, the UE reports CSI for ÑM ports in addition to N*M′ channel gain measures. For example, if Nₛ=16, M=8, N*=5, Ñ=8 and M′=1 the number of ports for which a CSI value is reported reduces from 128 to 69.

According to aspects of the fourth solution, the network (e.g., the NE 102 or a gNB) uses CSI feedback received from one or more UEs to select which antenna port groups to be active and which to deactivate. Consider the system model described with reference to FIGS. 2A and 2B, where the NE 102 employs a precoding matrix P to transmit data symbols a to K UEs 104 in the DL. Each UE 104 applies a receive combining matrix Vₖ to estimate its symbols.

The overall receive matrix across all UEs 104 is denoted by a matrix V given in Equation (5). In the given system, the precoder and combiners can be selected to optimize various performance metrics such as the symbol error rate or the spectral efficiency (SE).

When minimizing the symbol error rate, the mean squared error between the transmitted and estimated symbols is given by

$$F ( P , V ) {=}^{Δ} E [ {‖ a - \hat{a} ‖}^{2} ] = Tr ( {R}_{e e} ) \qquad Eq . ( 8 )$$

where the dependence of the error on the precoder and the combiners is explicitly denoted. Here Rₑₑ [symbol] E[(a-â)(a-â)^{H}] is the estimation error covariance given as

$${R}_{e e} = V H P {P}^{H} {H}^{H} {V}^{H} - V H P - {P}^{H} {H}^{H} {V}^{H} + {VR}_{ZZ} {V}^{H} + I s \qquad Eq . ( 9 )$$

Here, the goal is to minimize F (P, V) while ensuring that the number of active port groups is less than a pre-defined number. In other words, to minimize the symbol error rate, it is necessary to solve the following problem:

$${min}_{P , {V}_{1} , … , {V}_{K}} F ( P , diag ( {V}_{1} , … , {V}_{K} ) ) \qquad ( P0 )$$

$$subject to Tr ( {P}^{H} P ) = {P}_{tx}$$

$$‖ P ‖ ( 2 , 0 ) , B \leq v$$

where v is a non-negative integer, and ∥P∥_{(2,0),B}=Σₙ₌₁^{N}^{ₛ} I(∥\tilde{P}ₙ∥_{F}≠0) counts the number of non-zero row blocks in P (I(·) is the indicator function). This function may be referred to as the [symbol] _{2,0}-block-pseudo-norm. In the formulation of P₀ the condition that V should be block diagonal is enforced.

The problem P₀ is non-convex, since both the cost and the constraints are non-convex. This problem may be relaxed and then solved with an alternating optimization method. The relaxation consists of replacing the [symbol] _{2,0}-block-pseudo-norm with an [symbol] _{2,1}-block-norm and add that norm as a regularization term in the cost instead of enforcing it as a constraint. The [symbol] _{2,1}-block-norm is defined as

$${‖ P ‖}_{( 2 , 1 ) B} \hat{=} {\sum }_{n} {‖ {\tilde{P}}_{n} ‖}_{F} \qquad Eq . ( 10 )$$

It has the advantage of being convex and it promotes block-sparsity in the solution. The relaxed alternative to problem P0 is given as

$${min}_{P , {V}_{1} , … , {V}_{K}} F ( P , diag ( {V}_{1} , … , {V}_{K} ) ) + λ {‖ P ‖}_{( 2 , 1 ) , B}$$

$$subject to Tr ( {P}^{H} P ) = {P}_{tx}$$

where λ>0 is a pre-defined scalar that controls the effect of the regularization term and indirectly determines how block-sparse P is.

The necessary conditions can be derived for the optima of P₁ using the Lagrangian form and taking derivatives. This will show that, for a fixed precoder P, the optimal combining matrix at UE k must satisfy

$${V}_{k} = {P}_{k}^{H} {{H}_{k}^{H} ( {H}_{k} {PP}^{H} {H}_{k}^{H} + {R}_{zz , k} )}^{- 1} , k = 1 , … , K . \qquad Eq . ( 11 )$$

This will be useful in the solution techniques described below.

One solution to P₁ is obtained by alternating optimization over P and {V₁, . . . , V_{K}}. In order to do this, first initialize the precoder with a first guess, e.g., a random complex-valued matrix P⁽⁰⁾ that satisfies Tr(P^{(0)H}P⁽⁰⁾)=Pₜₓ. Then, iteratively optimize P₁ first over Vas P is fixed, then fixing the solution for V and optimizing over Puntil a stopping condition is met. This is known as block coordinate descent (BCD). The optimization sub-problem over V is

$$\{ {V}_{1}^{( t )} , … , {V}_{K}^{( t )} \} = arg {min}_{{V}_{1} , … , {V}_{K}} F ( {P}^{( t )} , diag ( {V}_{1} , … , {V}_{K} ) ) \qquad Eq . ( 12 )$$

and its solution is given in closed form via the necessary optimality condition in Equation (11). The optimization sub-problem over P is the following:

$${P}^{( t )} = arg {min}_{Q} F ( Q , {V}^{( t )} ) + λ {‖ Q ‖}_{( 2 , 1 ) , B} s . t . Tr ( {Q}^{H} Q ) = {P}_{tx} . \qquad ( {P}_{1} - sub )$$

where V^{(t)} is the solution for V in iteration t.

The problem (P₁-sub) may be solved via an iterative proximal method. The cost function in (P₁-sub) consists of a smooth and convex component f(Q) [symbol] F(Q, V^{(t)}) and a non-smooth (and convex) component [symbol] (Q) [symbol] λ∥Q∥_{(2,1),B} and the problem can be expressed as

$${min}_{Q} f ( Q ) + g ( Q ) s . t . Tr ( {Q}^{H} Q ) = {P}_{tx} \qquad Eq . ( 13 )$$

Without the constraint, a classic proximal method is expressed by the iterations

$${Q}^{( i + 1 )} = {prox}_{{α}_{i} g} ( {Q}^{( i )} - {α}_{i} ∇ f ( {Q}^{( i )} ) ) , i = 0 , 1 , … \qquad Eq . ( 14 )$$

for a given initial value Q⁽⁰⁾ where ∇f(Q⁽ⁱ⁾) is the gradient of f at Q⁽ⁱ⁾, αᵢ is a step size and [symbol] is the proximal operator of [symbol] .

Regarding the proximal operator, recall that [symbol] (Q)=λ Σₙ₌₁^{N}^{ₛ}∥\tilde{Q}ₙ∥_{F}, where each block \tilde{Q}ₙ corresponds to a group of consecutive rows in Q. The proximal operator of [symbol] at a point X with parameter α>0 is

$${prox}_{α g} ( X ) = arg {min}_{P} \{ λ {\sum }_{n = 1}^{{N}_{s}} {‖ {P}_{n} ‖}_{F} + \frac{1}{2 α} {‖ P - X ‖}_{F}^{2} \} .$$

Because the objective is separable across the blocks, the problem can be solved with respect to each block independently. For block n, let Xₙ be the corresponding row-block of X. The solution is given by

$${( {prox}_{α g} ( X ) )}_{n} = \{ \begin{matrix}0 , if {‖ {X}_{n} ‖}_{F} \leq α λ , \\ ( 1 - \frac{α λ}{{‖ {X}_{n} ‖}_{F}} ) {X}_{n} , otherwise\end{matrix} . \qquad Eq . ( 15 )$$

Hence, the proximal operator is a block-wise Frobenius-norm soft-thresholding step, shrinking each block of X by αλ in its Frobenius norm. The gradient of f with respect to Q is given by

$$∇ f ( {Q}^{( i )} ) = 2 {H}^{H} {V}^{( t ) H} {V}^{( t )} {HQ}^{( i )} - 2 {H}^{H} {V}^{( t ) H} \qquad Eq . ( 16 )$$

Therefore, the iterations in Equation (14) can be performed, having the gradient and the proximal operator. The iterations will halt when some stopping condition is met, such as

$$\frac{{‖ {Q}^{( i + 1 )} - {Q}^{( i )} ‖}_{F}}{{‖ {Q}^{( i )} ‖}_{F}} \leq ϵ$$

where ∈<0 is a small value.

The problem needs a further step due to the power constraint in (P₁-sub). This constraint may be handled by projecting the result of the proximal step onto the set Sp={Q: Tr(QQ^{H})=Pₜₓ}. This set is a sphere in the Frobenius norm and the projection of a matrix X onto this set is given by

$${\prod }_{Sp} ( X ) = \{ \begin{matrix}\frac{\sqrt{{P}_{tx}}}{{‖ {X}_{n} ‖}_{F}} X , & if X \neq 0 , \\ 0 , & if X = 0\end{matrix} . \qquad Eq . ( 17 )$$

After applying the proximal operator, the outcome may be projected to the sphere and move on to the next iteration.

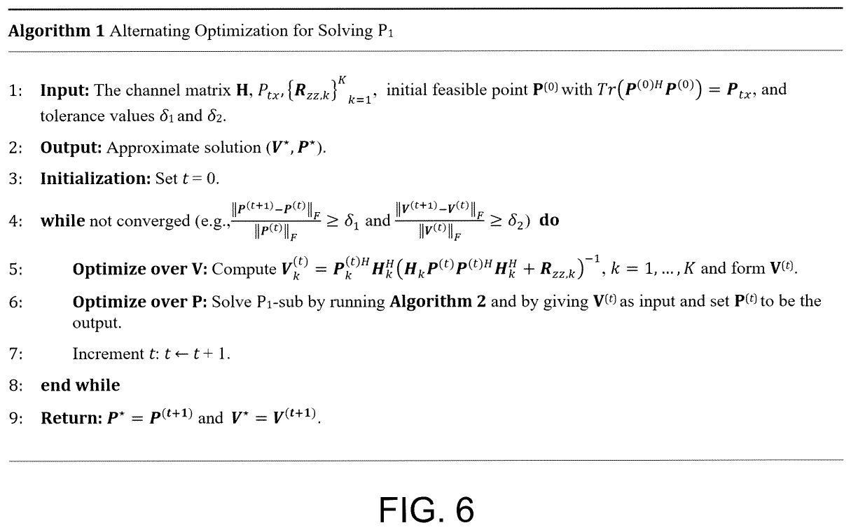

FIG. 6 illustrates an example of a first algorithm (denoted “Algorithm 1’) for solving P₁, e.g., using the alternating optimization method in accordance with aspects of the present disclosure. The first algorithm may be implemented by aspects of the wireless communication system 100. For example, the NE 102 may perform the first algorithm.

At Step 1, inputs are gathered including the channel matrix H, an initial feasible point, and tolerance values. At Step 2, an approximate solution is output. At Step 3, the variable t is initialized.

Step 4-8 are a “while” loop performed until the tolerance values are achieved. At Step 5, the matrix Vis optimized first as P is fixed. At Step 6, the precoder P is optimized as V is fixed. At Step 7, the variable t is incremented.

At Step 9, the optimized precoder P and matrix V are output once the stopping condition is met, i.e., the tolerance values are satisfied.

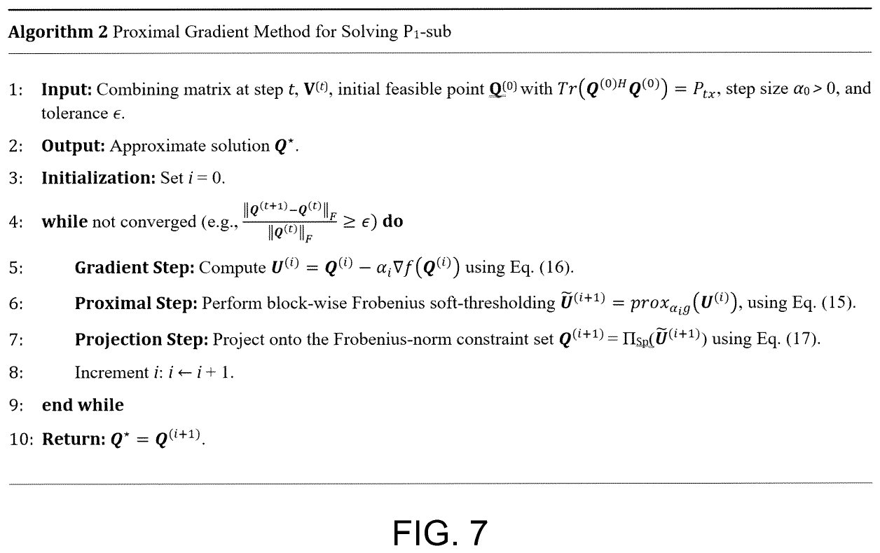

FIG. 7 illustrates an example of a second algorithm (denoted “Algorithm 2”) for solving P₁-sub, e.g., using the proximal gradient method in accordance with aspects of the present disclosure. The second algorithm may be implemented by aspects of the wireless communication system 100. For example, the NE 102 may perform the second algorithm. t Algorithm 2 is used in step 6 of Algorithm 1 to iteratively optimize the precoder P.

At Step 1, inputs are gathered including the combining matrix V, an initial feasible point, a step size, and a tolerance value. At Step 2, an approximate solution is output. At Step 3, the variable i is initialized.

Step 4-9 are a “while” loop performed until the tolerance values are achieved. At Step 5, the gradient step is calculated. At Step 6, the proximal step is calculated. At Step 7, the projection step is calculated. At Step 8, the variable i is incremented.

At Step 10, the optimized matrix Q is output once the stopping condition is met, i.e., the tolerance value is satisfied.

As an example of how the active port groups can be determined, the NE 102 may implement the following procedure. After calculating the outcome of Algorithm 1, the NE 102 may determine the active port groups by obtaining the Frobenius norm of each row block of P*, corresponding to each port group and specifying the ones with the largest norm.

Let {b⁽¹⁾, . . . , b^{(G)}} denote the sorted (in ascending order) block norms, corresponding to blocks {j₁, . . . , j_{G}}. The NE 102 may activate those port groups that contain a significant percentage (e.g., x=0.95) of the sum of block norms, i.e.

$${N}_{a} = min \{ n : {\sum }_{ℓ = 1}^{n} {b}^{( ℓ )} \geq x {\sum }_{ℓ = 1}^{{N}_{s}} {b}^{( ℓ )} \}$$

where the indices of active port groups are given by {j₁, . . . , j_{g}*}.

The number of active port groups may be controlled indirectly by the scalar λ in P₁. Larger values of λ induce more block sparsity (more inactive port groups) in the solution, whereas smaller values of λ induce less sparsity. However, one cannot simply relate the desired number of active port groups to a corresponding value of λ. Nevertheless, it is understood that the block-sparsity of P* is non-decreasing as a function of λ. This suggests a way for determining the appropriate value for lambda via a line search.

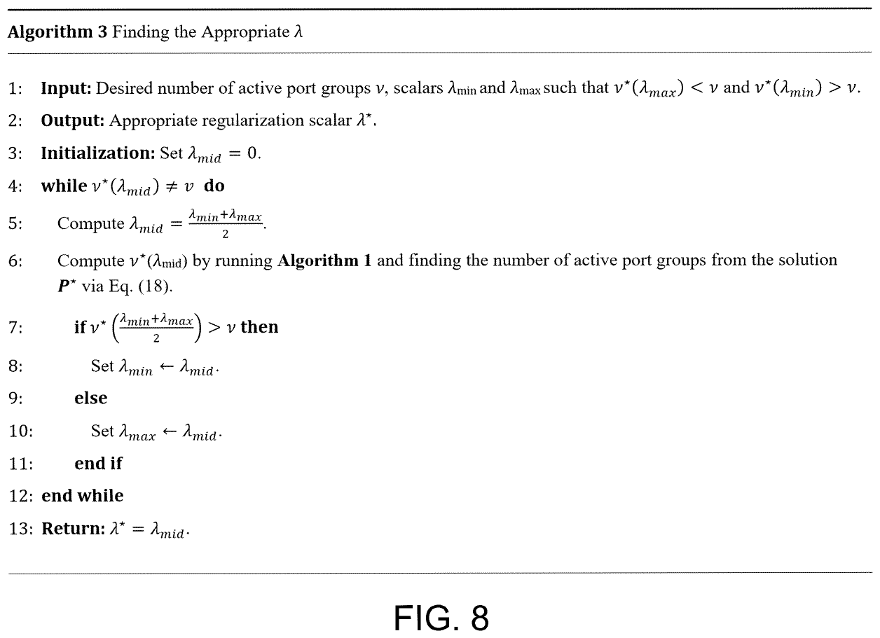

FIG. 8 illustrates an example of a third algorithm (denoted “Algorithm 3”) for finding the regularization scalar λ that yields the desired v*(λ)=v in accordance with aspects of the present disclosure. The third algorithm may be implemented by aspects of the wireless communication system 100. For example, the NE 102 may perform the third algorithm. Let v*(λ) denote the number of active port groups in the solution of P₁ according to Algorithm 1 for a specific λ. Also let v be a desired number of active port groups.

At Step 1, inputs are gathered including the desired number of active port groups and maximum and minimum scalars. At Step 2, an appropriate regularization scalar is output. At Step 3, the variable λmid is initialized.

Step 4-12 are a “while” loop performed until the desired number of active port groups is achieved. At Step 5, the variable λmid is set to the scalar average. At Step 6, a number of active port groups is calculated using Algorithm 1 and Equation (18).

Steps 7-11 are an if/else condition for adjusting maximum or minimum scalar based on the result of Step 6. At Step 10, the optimized scalar λ that yields the desired number of active port groups is output.

The formulation of the problem P₀ depends on the raw channel coefficients for each UE Hₖ, k=1, . . . , K, which are not necessarily available at the gNB. In TDD the gNB can estimate raw channel coefficients from SRS. However, in FDD the gNB only has access to UE's preferred precoding vectors via PMI feedback. The preferred precoder for UE k, denoted by \tilde{P}ₖ of dimension N_{T}×Sₖ corresponds to the “effective channel,” namely the concatenation of the UE receiver and its channel defined as H_{eff,k}=VₖHₖ. Therefore when the PMI is given, the optimization may be bypassed with respect to V and optimize only with respect to P by replacing the terms VₖHₖ with \tilde{P}ₖ^{H} for all k.

Eventually, only P₁-sub need to be solved (e.g., using Algorithm 2) to find the best precoder and set of active port groups. Although this is an easier problem to solve compared to P₁ the quality of multi-user precoder obtained from solving P₁ is likely to be higher because optimization is performed not only with respect to the precoder but also with respect to UE receivers.

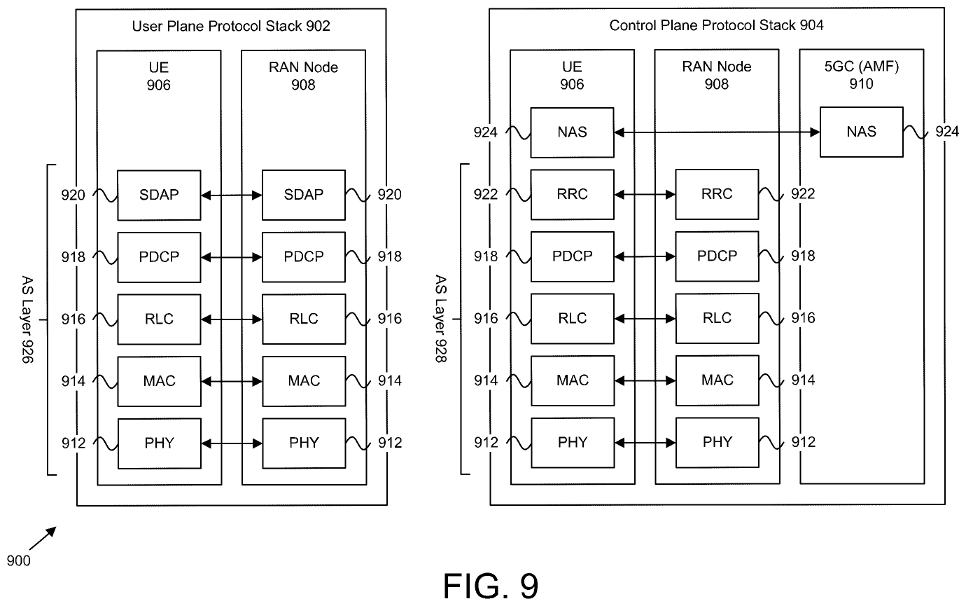

DONE FIG. 9 illustrates an example of a protocol stack 900, in accordance with

aspects of the present disclosure. While FIG. 9 shows a UE 906, a RAN node 908, and a 5GC 910 (e.g., including at least an AMF), these are representative of a set of UEs 104 interacting with an NE 102 (e.g., base station) and a CN 106. As depicted, the protocol stack 900 includes a user plane protocol stack 902 and a control plane protocol stack 904. The user plane protocol stack 902 includes a physical (PHY) layer 912, a MAC sublayer 914, a radio link control (RLC) sublayer 916, a packet data convergence protocol (PDCP) sublayer 918, and a service data adaptation protocol (SDAP) sublayer 920. The control plane protocol stack 904 includes a PHY layer 912, a MAC sublayer 914, an RLC sublayer 916, and a PDCP sublayer 918. The Control Plane protocol stack 904 also includes a radio resource control (RRC) layer 922 and a non-access stratum (NAS) layer 924.

The AS layer 926 (also referred to as “AS protocol stack”) for the user plane protocol stack 902 consists of at least the SDAP sublayer 920, the PDCP sublayer 918, the RLC sublayer 916, the MAC sublayer 914, and the PHY layer 912. The AS layer 928 for the control plane protocol stack 904 consists of at least the RRC layer 922, the PDCP sublayer 918, the RLC sublayer 916, the MAC sublayer 914, and the PHY layer 912. The layer-1 (L1) includes the PHY layer 912. The layer-2 (L2) is split into the SDAP sublayer 920, PDCP sublayer 918, RLC sublayer 916, and MAC sublayer 914. The layer-3 (L3) includes the RRC layer 922 and the NAS layer 924 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 912 offers transport channels to the MAC sublayer 914. The PHY layer 912 may perform a beam failure detection procedure using energy detection thresholds, as described herein. In certain embodiments, the PHY layer 912 may send an indication of beam failure to a MAC entity at the MAC sublayer 914. The MAC sublayer 914 offers logical channels (LCHs) to the RLC sublayer 916. The RLC sublayer 916 offers RLC channels to the PDCP sublayer 918.

The PDCP sublayer 918 offers radio bearers to the SDAP sublayer 920 and/or RRC layer 922. The SDAP sublayer 920 offers QoS flows to the core network (e.g., 5GC). The RRC layer 922 provides for the addition, modification, and release of carrier aggregation (CA) and/or dual connectivity. The RRC layer 922 also manages the establishment, configuration, maintenance, and release of signaling radio bearers (SRBs) and data radio bearers (DRBs).

The NAS layer 924 is between the UE 906 and an AMF in the 5GC 910. NAS messages are passed transparently through the RAN. The NAS layer 924 is used to manage the establishment of communication sessions and for maintaining continuous communications with the UE 906 as it moves between different cells of the RAN. In contrast, the AS layers 926 and 928 are between the UE 906 and the RAN (i.e., RAN node 908) and carry information over the wireless portion of the network. While not depicted in FIG. 9, the IP layer exists above the NAS layer 924, a transport layer exists above the IP layer, and an application layer exists above the transport layer.

The MAC sublayer 914 is the lowest sublayer in the L2 architecture of the NR protocol stack. Its connection to the PHY layer 912 below is through transport channels, and the connection to the RLC sublayer 916 above is through LCHs. The MAC sublayer 914 therefore performs multiplexing and demultiplexing between LCHs and transport channels: the MAC sublayer 914 in the transmitting side constructs MAC PDUs (also known as transport blocks (TBs)) from MAC service data units (SDUs) received through LCHs, and the MAC sublayer 914 in the receiving side recovers MAC SDUs from MAC PDUs received through transport channels.

The MAC sublayer 914 provides a data transfer service for the RLC sublayer 916 through LCHs, which are either control LCHs which carry control data (e.g., RRC signaling) or traffic LCHs which carry user plane data. On the other hand, the data from the MAC sublayer 914 is exchanged with the PHY layer 912 through transport channels, which are classified as UL or DL. Data is multiplexed into transport channels depending on how it is transmitted over the air.

The PHY layer 912 is responsible for the actual transmission of data and control information via the air interface, i.e., the PHY layer 912 carries all information from the MAC transport channels over the air interface on the transmission side. Some of the important functions performed by the PHY layer 912 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 922. The PHY layer 912 performs transmissions based on transmission parameters, such as the modulation scheme, the coding rate (i.e., the modulation and coding scheme (MCS)), the number of physical resource blocks (PRBs), etc.

In some embodiments, the protocol stack 900 may be an NR protocol stack used in a 5G NR system. An LTE protocol stack includes a similar structure to the protocol stack 900, with the differences that the LTE protocol stack lacks the SDAP sublayer 920 in the AS layer 926, that an EPC replaces the 5GC 910, and that the NAS layer 924 is between the UE 906 and an MME in the EPC. Also, the present disclosure distinguishes between a protocol layer (such as the aforementioned PHY layer 912, MAC sublayer 914, RLC sublayer 916, PDCP sublayer 918, SDAP sublayer 920, RRC layer 922 and NAS layer 924) and a transmission layer in MIMO communication (also referred to as a “MIMO layer” or a “data stream”).

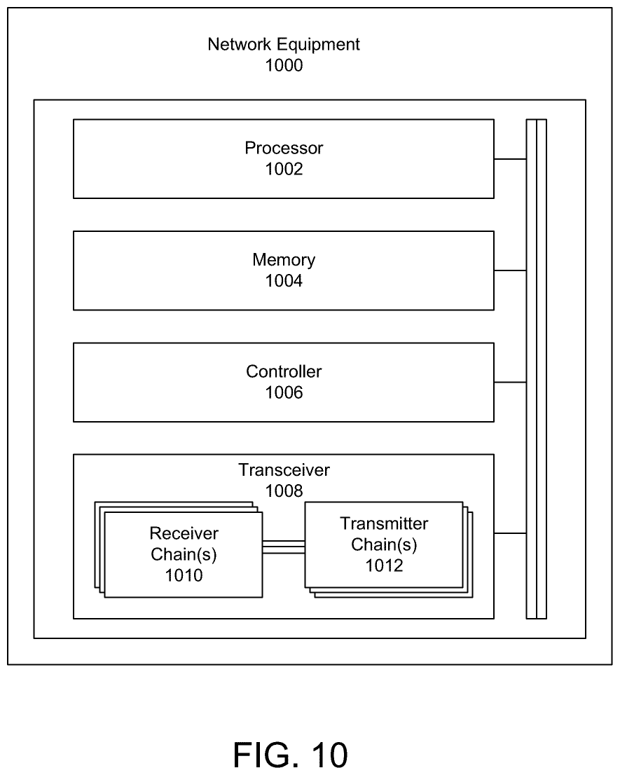

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field programmable gate array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions that, when executed by the processor 1002, cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform various functions (e.g., operations, signaling) described herein (e.g., executing, by the processor 1002, instructions stored in the memory 1004). In some implementations, the processor 1002 may include multiple processors and the memory 1004 may include multiple memories. One or more of the multiple processors may be coupled with one or more of the multiple memories, which may be individually or collectively, configured to perform various functions (e.g., operations, signaling) of the UE 1000 as described herein.

In some implementations, the processor 1002 and the memory 1004 coupled with the processor 1002 may be configured to cause the UE 1000 to perform various functions (e.g., operations, signaling) of a first wireless node. For example, the processor 1002 coupled with the memory 1004 may be configured to, capable of, or operable to cause the UE 1000 to receive, from a network node, a channel state information (CSI) reporting configuration; receive a set of CSI reference signal (CSI-RS), where the set of CSI-RS is associated with a plurality of port groups; select a subset of port groups from the plurality of port groups, based on the received set of CSI-RS and the CSI reporting configuration; generate a CSI report including an indication of the selected subset of port groups and a channel measurement corresponding to the selected subset of port groups; and transmit the CSI report to the network node.

In some implementations, the indication of the selected subset of port groups includes a plurality of indices corresponding to the selected subset of port groups, and where a number of reported indices corresponding to the selected subset of port groups is included in the CSI reporting configuration.

In some implementations, to select the subset of port groups, the processor 1002 coupled with the memory 1004 may be configured to, capable of, or operable to cause the UE 1000 to determine a channel gain associated with each port group of the subset of port groups and to select a configured number of port groups having a largest channel gain in the determined channel gains, where the configured number of port groups is indicated in the CSI reporting configuration.

In some implementations, to select the subset of port groups, the processor 1002 coupled with the memory 1004 may be configured to, capable of, or operable to cause the UE 1000 to determine a wideband CQI value or an average sub-band CQI value for each port group and to select a configured number of port groups having a largest wideband CQI values or largest average sub-band CQI values, where the configured number of port groups is indicated in the CSI reporting configuration.

In some implementations, the channel measurement corresponding to the selected subset of port groups includes one or more of: A) at least one PMI value including coefficients associated with the selected subset of port groups; B) at least one RI value corresponding to the selected subset of port groups; C) at least one wideband CQI value corresponding to the selected subset of port groups; or D) at least one sub-band CQI value corresponding to the selected subset of port groups; or a combination thereof.

In certain implementations, the CSI report includes separate channel measurement indications for each port group of the selected subset of port groups, and where each channel measurement indication includes a respective PMI value, a respective RI value, a respective wideband CQI value, and a respective sub-band CQI value. In certain implementations, the CSI report includes a combined channel measurement indication for the selected subset of port groups.

In some implementations, the number of CSI-RS received per port group is greater than the number of antenna elements per port group. In certain implementations, the set of CSI-RS includes a first subset of CSI-RS and a second subset of CSI-RS, where the first subset of CSI-RS includes a plurality of single-port resources corresponding to the plurality of port groups, and where the second subset of CSI-RS is associated with a plurality of ports corresponding to a subset of the plurality of port groups. In certain implementations, each resource in the plurality of single-port resources is quasi-co-located with a distinct port group of the plurality of port groups, and each port group consists of a plurality of antenna ports.

In certain implementations, the processor 1002 coupled with the memory 1004 may be configured to, capable of, or operable to cause the UE 1000 to: A) determine a channel gain associated with each port group based on the first subset of CSI-RS; B) select the subset of port groups based on the channel gain; and C) determine the channel measurement corresponding to the selected subset of port groups based on the second subset of CSI-RS, where the second subset of CSI-RS is associated with the plurality of port groups.

In some implementations, the set of CSI-RS includes a first subset of CSI-RS and a second subset of CSI-RS, and where the processor 1002 coupled with the memory 1004 may be configured to, capable of, or operable to cause the UE 1000 to: A) determine a channel gain associated with each port group based on the first subset of CSI-RS; B) select the subset of port groups based on the channel gain; C) transmit the CSI report including the indication of the selected subset of port groups and the channel gain associated with each port group of the selected subset of port groups; and D) receive the second subset of CSI-RS and a second CSI reporting configuration in response to reporting the channel gain, where the second subset of CSI-RS is associated with a second subset of port groups from the plurality of port groups, and where each port group consists of a plurality of antenna ports.

In certain implementations, the processor 1002 coupled with the memory 1004 may be configured to, capable of, or operable to cause the UE 1000 to generate a second CSI report based on the second subset of CSI-RS and the second CSI reporting configuration, where the second CSI report includes one or more of: A) a PMI value including coefficients associated with the second subset of CSI-RS; B) a RI value corresponding to the second subset of CSI-RS; C) a wideband CQI value corresponding to the second subset of the CSI-RS; or D) a sub-band CQI value corresponding to the second subset of the CSI-RS; or a combination thereof.

In such implementations, the processor 1002 coupled with the memory 1004 may be configured to, capable of, or operable to cause the UE 1000 to transmit the second CSI report to the network node. In certain implementations, the second CSI report includes separate channel measurement indications for each port group of the second subset of CSI-RS, and where each channel measurement indication includes a respective PMI value, a respective RI value, a respective wideband CQI value, and a respective sub-band CQI value for a respective port group of the second subset of CSI-RS.

The controller 1006 may manage input and output signals for the UE 1000. The controller 1006 may also manage peripherals not integrated into the UE 1000. In some implementations, the controller 1006 may utilize an operating system (OS) such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

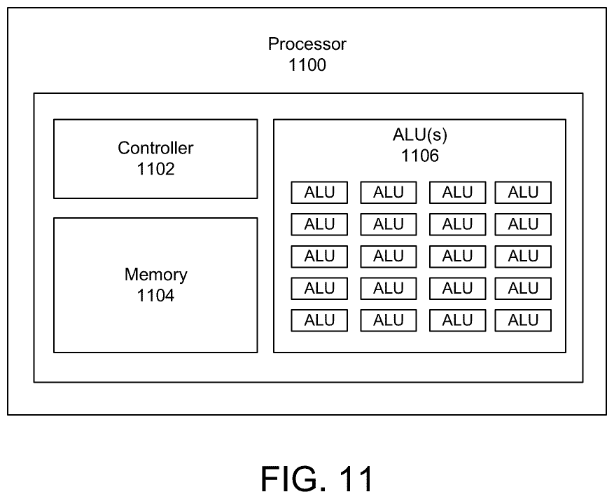

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1, or L2, or L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

In some implementations, the processor 1100 may support various functions (e.g., operations, signaling) of a UE, in accordance with examples as disclosed herein. For example, the controller 1102 coupled with the memory 1104 may be configured to, capable of, or operable to cause the processor 1100 to receive, from a network node, a channel state information (CSI) reporting configuration; receive a set of CSI reference signal (CSI-RS), where the set of CSI-RS is associated with a plurality of port groups; select a subset of port groups from the plurality of port groups, based on the received set of CSI-RS and the CSI reporting configuration; generate a CSI report including an indication of the selected subset of port groups and a channel measurement corresponding to the selected subset of port groups; and transmit the CSI report to the network node. Additionally, the controller 1102 coupled with the memory 1104 may be configured to, capable of, or operable to cause the processor 1100 to perform one or more functions (e.g., operations, signaling) of the UE as described herein.

Additionally, or alternatively, in some other implementations, the processor 1100 may support various functions (e.g., operations, signaling) of a base station, in accordance with examples as disclosed herein. For example, the controller 1102 coupled with the memory 1104 may be configured to, capable of, or operable to cause the processor 1100 to transmit, to a UE, a CSI reporting configuration; transmit a set of CSI-RS, where the set of CSI-RS is associated with a plurality of port groups; receive a CSI report from the UE, the CSI report including an indication of a selected subset of port groups and a channel measurement corresponding to the selected subset of port groups; select a second subset of active port groups from the plurality of port groups, based on the received CSI report; and deactivate a remainder of the plurality of port groups. Additionally, the controller 1102 coupled with the memory 1104 may be configured to, capable of, or operable to cause the processor 1100 to perform one or more functions (e.g., operations, signaling) of the base station as described herein.

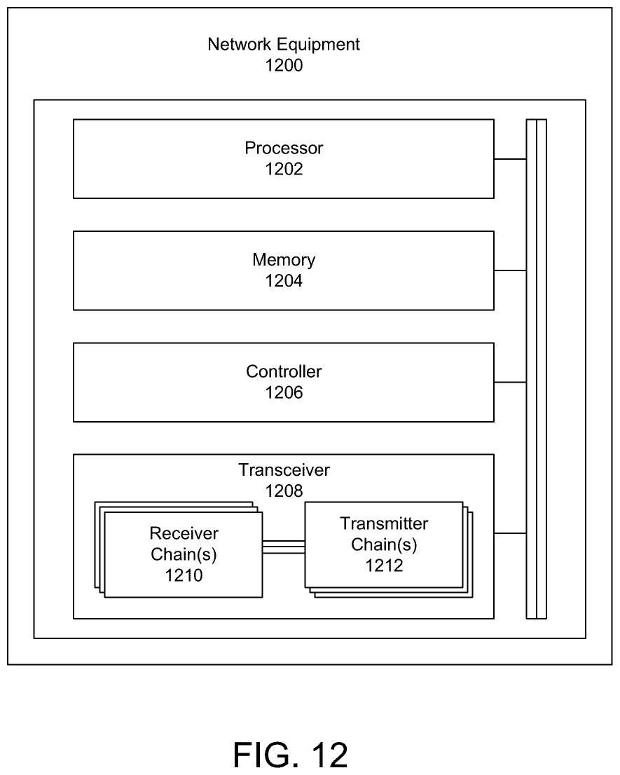

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform various functions (e.g., operations, signaling) described herein (e.g., executing, by the processor 1202, instructions stored in the memory 1204). In some implementations, the processor 1202 may include multiple processors and the memory 1204 may include multiple memories. One or more of the multiple processors may be coupled with one or more of the multiple memories, which may be individually or collectively, configured to perform various functions (e.g., operations, signaling) of the NE 1200 as described herein.

In some implementations, the processor 1202 and the memory 1204 coupled with the processor 1202 may be configured to cause the NE 1200 to perform various functions (e.g., operations, signaling) of a first wireless node. For example, the processor 1202 coupled with the memory 1204 may be configured to, capable of, or operable to cause the NE 1200 to transmit, to a UE, a CSI reporting configuration; transmit a set of CSI-RS, where the set of CSI-RS is associated with a plurality of port groups; receive a CSI report from the UE, the CSI report including an indication of a selected subset of port groups and a channel measurement corresponding to the selected subset of port groups; select a second subset of active port groups from the plurality of port groups, based on the received CSI report; and deactivate a remainder of the plurality of port groups.

In some implementations, the indication of the selected subset of port groups includes a plurality of indices corresponding to the selected subset of port groups, and where a number of reported indices corresponding to the selected subset of port groups is included in the CSI reporting configuration.

In some implementations, the channel measurement corresponding to the selected subset of port groups includes one or more of: A) at least one PMI value including coefficients associated with the selected subset of port groups; B) at least one RI value corresponding to the selected subset of port groups; C) at least one wideband CQI value corresponding to the selected subset of port groups; or D) at least one sub-band CQI value corresponding to the selected subset of port groups; or a combination thereof.

In certain implementations, the CSI report includes separate channel measurement indications for each port group of the selected subset of port groups, and where each channel measurement indication includes a respective PMI value, a respective RI value, a respective wideband CQI value, and a respective sub-band CQI value. In certain implementations, the CSI report includes a combined channel measurement indication for the selected subset of port groups.

In some implementations, the number of CSI-RS transmitted per port group is greater than the number of antenna elements per port group. In certain implementations, the set of CSI-RS includes a first subset of CSI-RS and a second subset of CSI-RS, where the first subset of CSI-RS includes a plurality of single-port resources corresponding to the plurality of port groups, and where the second subset of CSI-RS is associated with a plurality of ports corresponding to a subset of the plurality of port groups. In certain implementations, each resource in the plurality of single-port resources is quasi-co-located with a distinct port group of the plurality of port groups.

In some implementations, the set of CSI-RS includes a first subset of CSI-RS and a second subset of CSI-RS, where the CSI report includes the indication of the selected subset of port groups and a channel gain associated with each port group of the selected subset of port groups. In such implementations, the processor 1202 coupled with the memory 1204 may be configured to, capable of, or operable to cause the NE 1200 to select a second subset of port groups based on the channel gain and to transmit the second subset of CSI-RS and a second CSI reporting configuration in response to reporting the channel gain, where the second subset of CSI-RS is associated with the second subset of port groups, and where each port group consists of a plurality of antenna ports.

In some implementations, the set of CSI-RS includes a first subset of CSI-RS and a second subset of CSI-RS, and where the processor 1202 coupled with the memory 1204 may be configured to, capable of, or operable to cause the NE 1200 to receive a second CSI report based on the second subset of CSI-RS and the second CSI reporting configuration, where the second CSI report includes one or more of: A) a PMI value including coefficients associated with the second subset of CSI-RS; B) a RI value corresponding to the second subset of CSI-RS; C) a wideband CQI value corresponding to the second subset of the CSI-RS; or D) a sub-band CQI value corresponding to the second subset of the CSI-RS; or a combination thereof.

In certain implementations, the second CSI report includes separate channel measurement indications for each port group of the second subset of CSI-RS, and where each channel measurement indication includes a respective PMI value, a respective RI value, a respective wideband CQI value, and a respective sub-band CQI value for a respective port group of the second subset of CSI-RS.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding/processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

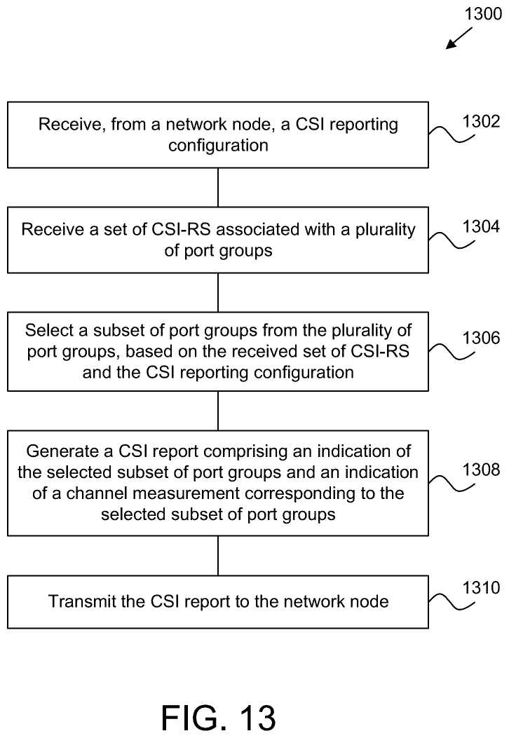

FIG. 13 illustrates a flowchart of a method 1300 in accordance with aspects of the present disclosure. The operations of the method 1300 may be implemented by a first wireless node as described herein. In some examples, the first wireless node may be implemented by a UE as described herein. Alternatively, the operations of the first wireless node may be implemented by a NE as described herein. In some implementations, the UE and/or NE may execute a set of instructions to control the function elements of the UE and/or NE to perform the described functions.

At step 1302, the method 1300 may include receiving, from a network node, a CSI reporting configuration. The operations of step 1302 may be performed in accordance with examples as described herein. In some implementations, aspects of the operations of step 1302 may be performed by a UE, as described with reference to FIG. 10.

At step 1304, the method 1300 may include receiving a set of CSI-RS, wherein the set of CSI-RS is associated with a plurality of port groups. The operations of step 1304 may be performed in accordance with examples as described herein. In some implementations, aspects of the operations of step 1304 may be performed by a UE, as described with reference to FIG. 10.

At step 1306, the method 1300 may include selecting a subset of port groups from the plurality of port groups, based on the received set of CSI-RS and the CSI reporting configuration. The operations of step 1306 may be performed in accordance with examples as described herein. In some implementations, aspects of the operations of step 1306 may be performed by a UE, as described with reference to FIG. 10.

At step 1308, the method 1300 may include generating a CSI report including an indication of the selected subset of port groups and a channel measurement corresponding to the selected subset of port groups. The operations of step 1308 may be performed in accordance with examples as described herein. In some implementations, aspects of the operations of step 1308 may be performed by a UE, as described with reference to FIG. 10.

At step 1310, the method 1300 may include transmitting the CSI report to the network node. The operations of step 1310 may be performed in accordance with examples as described herein. In some implementations, aspects of the operations of step 1310 may be performed by a UE, as described with reference to FIG. 10.

It should be noted that the method 1300 described herein describes one possible implementation, and that the operations and the steps may be rearranged or otherwise modified and that other implementations are possible.

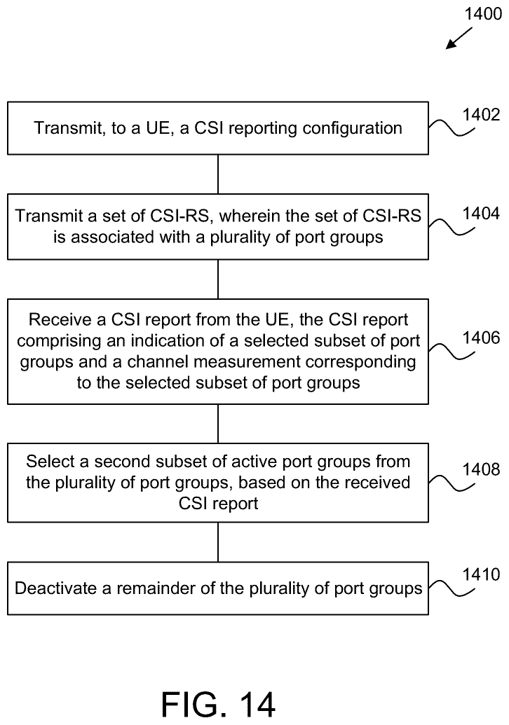

FIG. 14 illustrates a flowchart of a method 1400 in accordance with aspects of the present disclosure. The operations of the method 1400 may be implemented by a second wireless node as described herein. In some examples, the second wireless node may be implemented by a UE as described herein. Alternatively, the operations of the second wireless node may be implemented by a NE as described herein. In some implementations, the UE and/or NE may execute a set of instructions to control the function elements of the UE and/or NE to perform the described functions.

At step 1402, the method 1400 may include transmitting, to a UE, a CSI reporting configuration. The operations of step 1402 may be performed in accordance with examples as described herein. In some implementations, aspects of the operations of step 1402 may be performed by a NE, as described with reference to FIG. 12.

At step 1404, the method 1400 may include transmitting a set of CSI-RS, wherein the set of CSI-RS is associated with a plurality of port groups. The operations of step 1404 may be performed in accordance with examples as described herein. In some implementations, aspects of the operations of step 1404 may be performed by a NE, as described with reference to FIG. 12.

At step 1406, the method 1400 may include receiving a CSI report from the UE, the CSI report including an indication of a selected subset of port groups and a channel measurement corresponding to the selected subset of port groups. The operations of step 1406 may be performed in accordance with examples as described herein. In some implementations, aspects of the operations of step 1406 may be performed by a NE, as described with reference to FIG. 12.

At step 1408, the method 1400 may include selecting a second subset of active port groups from the plurality of port groups, based on the received CSI report. The operations of step 1408 may be performed in accordance with examples as described herein. In some implementations, aspects of the operations of step 1404 may be performed by a NE, as described with reference to FIG. 12.

At step 1410, the method 1400 may include deactivating a remainder of the plurality of port groups. The operations of step 1410 may be performed in accordance with examples as described herein. In some implementations, aspects of the operations of step 1410 may be performed by a NE, as described with reference to FIG. 12.

It should be noted that the method 1400 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network node, a channel state information (CSI) reporting configuration;
receive a set of CSI reference signals (CSI-RS) associated with a plurality of port groups;
select a subset of port groups from the plurality of port groups, based on the received set of CSI-RS and the CSI reporting configuration;
generate a CSI report comprising an indication of the selected subset of port groups and an indication of a channel measurement corresponding to the selected subset of port groups; and
transmit the CSI report to the network node.

2. The UE of claim 1, wherein the indication of the selected subset of port groups comprises a plurality of indices corresponding to the selected subset of port groups, and wherein a number of reported indices corresponding to the selected subset of port groups is included in the CSI reporting configuration.

3. The UE of claim 1, wherein to select the subset of port groups, the at least one processor is configured to cause the UE to:
determine a channel gain associated with each port group of the subset of port groups; and
select a configured number of port groups having a largest channel gain in the determined channel gains,
wherein the configured number of port groups is indicated in the CSI reporting configuration.

4. The UE of claim 1, wherein to select the subset of port groups, the at least one processor is configured to cause the UE to:
determine a wideband channel quality indicator (CQI) value or an average sub-band CQI value for each port group; and
select a configured number of port groups having a largest wideband CQI values or largest average sub-band CQI values,
wherein the configured number of port groups is indicated in the CSI reporting configuration.

5. The UE of claim 1, wherein the channel measurement corresponding to the selected subset of port groups comprises one or more of:
at least one precoding matrix indicator (PMI) value comprising coefficients associated with the selected subset of port groups;
at least one rank indicator (RI) value corresponding to the selected subset of port groups;
at least one wideband channel quality indicator (CQI) value corresponding to the selected subset of port groups; and
at least one sub-band CQI value corresponding to the selected subset of port groups.

6. The UE of claim 5, wherein the CSI report comprises separate channel measurement indications for each port group of the selected subset of port groups, and wherein each channel measurement indication comprises a respective PMI value, a respective RI value, a respective wideband CQI value, and a respective sub-band CQI value.

7. The UE of claim 5, wherein the CSI report comprises a combined channel measurement indication for the selected subset of port groups.

8. The UE of claim 1, wherein a number of CSI-RS received per port group is greater than a number of antenna elements per port group.

9. The UE of claim 8, wherein the set of CSI-RS comprises a first subset of CSI-RS and a second subset of CSI-RS, wherein the first subset of CSI-RS comprises a plurality of single-port resources corresponding to the plurality of port groups, and wherein the second subset of CSI-RS is associated with a plurality of ports associated with a subset of the plurality of port groups.

10. The UE of claim 9, wherein each resource in the plurality of single-port resources is quasi-co-located with a distinct port group of the plurality of port groups.

11. The UE of claim 9, wherein the at least one processor is configured to cause the UE to:
determine a channel gain associated with each port group based on the first subset of CSI-RS;
select the subset of port groups based on the channel gain; and
determine the channel measurement corresponding to the selected subset of port groups based on the second subset of CSI-RS,
wherein the second subset of CSI-RS is associated with the plurality of port groups, and wherein each port group consists of a plurality of antenna ports.

12. The UE of claim 1, wherein the set of CSI-RS comprises a first subset of CSI-RS and a second subset of CSI-RS, and wherein the at least one processor is configured to cause the UE to:
determine a channel gain associated with each port group based on the first subset of CSI-RS;
select the subset of port groups based on the channel gain;
transmit the CSI report comprising the indication of the selected subset of port groups and the channel gain associated with each port group of the selected subset of port groups; and
receive the second subset of CSI-RS and a second CSI reporting configuration in response to reporting the channel gain,
wherein the second subset of CSI-RS is associated with a second subset of port groups from the plurality of port groups, and wherein each port group consists of a plurality of antenna ports.

13. The UE of claim 12, wherein the at least one processor is configured to cause the UE to:
generate a second CSI report based on the second subset of CSI-RS and the second CSI reporting configuration, wherein the second CSI report comprises:
a precoding matrix indicator (PMI) value comprising coefficients associated with the second subset of CSI-RS;
a rank indicator (RI) value corresponding to the second subset of CSI-RS;
a wideband channel quality indicator (CQI) value corresponding to the second subset of the CSI-RS; or
a sub-band CQI value corresponding to the second subset of the CSI-RS; and
transmit the second CSI report to the network node.

14. The UE of claim 13, wherein the second CSI report comprises separate channel measurement indications for each port group of the second subset of CSI-RS, and wherein each channel measurement indication comprises a respective PMI value, a respective RI value, a respective wideband CQI value, and a respective sub-band CQI value for a respective port group of the second subset of CSI-RS.

15. A method performed by a user equipment (UE), the method comprising:
receiving, from a network node, a channel state information (CSI) reporting configuration;
receiving a set of CSI reference signal (CSI-RS), wherein the set of CSI-RS is associated with a plurality of port groups;
selecting a subset of port groups from the plurality of port groups, based on the received set of CSI-RS and the CSI reporting configuration;
generating a CSI report comprising an indication of the selected subset of port groups and a channel measurement corresponding to the selected subset of port groups; and
transmitting the CSI report to the network node.

16. A base station for wireless communication, comprising:
at least one memory; and
at least one processor coupled with the at least one memory and configured to cause the base station to:
transmit, to a user equipment (UE), a channel state information (CSI) reporting configuration;
transmit a set of CSI reference signal (CSI-RS), wherein the set of CSI-RS is associated with a plurality of port groups;
receive a CSI report from the UE, the CSI report comprising an indication of a selected subset of port groups and a channel measurement corresponding to the selected subset of port groups;
select a second subset of active port groups from the plurality of port groups, based on the received CSI report; and
deactivate a remainder of the plurality of port groups.

17. The base station of claim 16, wherein the indication of the selected subset of port groups comprises a plurality of indices corresponding to the selected subset of port groups, and wherein a number of reported indices corresponding to the selected subset of port groups is included in the CSI reporting configuration.

18. The base station of claim 16, wherein the set of CSI-RS comprises a first subset of CSI-RS and a second subset of CSI-RS, wherein the CSI report comprises the indication of the selected subset of port groups and a channel gain associated with each port group of the selected subset of port groups, and wherein the at least one processor is configured to cause the base station to:
select a second subset of port groups based on the channel gain; and
transmit the second subset of CSI-RS and a second CSI reporting configuration in response to reporting the channel gain, wherein the second subset of CSI-RS is associated with the second subset of port groups, and wherein each port group consists of a plurality of antenna ports.

19. The base station of claim 18, wherein the at least one processor is configured to cause the base station to:
receive a second CSI report based on the second subset of CSI-RS and the second CSI reporting configuration, wherein the second CSI report comprises:
a precoding matrix indicator (PMI) value comprising coefficients associated with the second subset of CSI-RS;
a rank indicator (RI) value corresponding to the second subset of CSI-RS;
a wideband channel quality indicator (CQI) value corresponding to the second subset of the CSI-RS; or
a sub-band CQI value corresponding to the second subset of the CSI-RS.

20. A method performed by a base station, the method comprising:
transmitting, to a user equipment (UE), a channel state information (CSI) reporting configuration;
transmitting a set of CSI reference signal (CSI-RS), wherein the set of CSI-RS is associated with a plurality of port groups;
receiving a CSI report from the UE, the CSI report comprising an indication of a selected subset of port groups and a channel measurement corresponding to the selected subset of port groups;
selecting a second subset of active port groups from the plurality of port groups, based on the received CSI report; and
deactivating a remainder of the plurality of port groups.
